(19) United States
(12) Patent Application Publication
(10) Pub. No.: US 2024/0367316 A1
(43) Pub. Date: Nov. 7, 2024

(54) MULTI-PURPOSE ROBOTS, SYSTEMS, COMPUTER PROGRAM PRODUCTS, AND METHODS FOR EVALUATING STATE REPRESENTATIONS OF THE SAME

(71) Applicant: Sanctuary Cognitive Systems Corporation, Vancouver (CA)

(72) Inventors: Suzanne Gildert, Vancouver (CA); Geordie Rose, Vancouver (CA)

(21) Appl. No.: 18/655,623

(22) Filed: May 6, 2024

Related U.S. Application Data
(60) Provisional application No. 63/464,416, filed on May 5, 2023.

(51) Int. Cl. B25J 9/16; G05B 19/4155

(52) U.S. Cl. CPC B25J 9/1656; B25J 9/163; G05B 19/4155; G05B 2219/50391

(57) ABSTRACT

Robots, systems, methods, and computer program products for completing work objectives and evaluating states of robots are described. A robot accesses a library of reusable work primitives, each reusable work primitive corresponding to a respective basic sub-action that the robot is trained to autonomously perform. Each reusable work primitive is paired with an associated percept, which is used to evaluate a state representation of a robot to determine whether a desired outcome for the reusable work primitive is achieved.

### TECHNICAL FIELD

The present robots, computer program products, and methods generally relate to evaluating state representations of said robots and computer program products, and particularly relate to determining whether metrics for state representations are satisfied.

### DESCRIPTION OF THE RELATED ART

Robots are machines that may be deployed to perform work. Robots may come in a variety of different form factors, including humanoid form factors. Humanoid robots may be operated by tele-operation systems through which the robot is caused to emulate the physical actions of a human operator or pilot; however, such tele-operation systems typically require very elaborate and complicated interfaces comprising sophisticated sensors and equipment worn by or otherwise directed towards the pilot, thus requiring that the pilot devote their full attention to the tele-operation of the robot and limiting the overall accessibility of the technology.

Robots may be trained or otherwise programmed to operate semi-autonomously or fully autonomously. There is a need for means for controlling operation of robots, and for evaluating when to perform actions as well as outcomes of actions.

### BRIEF SUMMARY

According to a broad aspect, the present disclosure describes a robot system comprising: a robot body; at least one sensor; a robot controller which includes at least one processor and at least one non-transitory processor-readable storage medium communicatively coupled to the at least one processor, the at least one processor-readable storage medium storing processor-executable instructions which when executed by the at least one processor cause the robot system to: access a first reusable work primitive from a library of reusable work primitives; access a first percept associated with the first reusable work primitive, wherein the first percept comprises a first metric for evaluating a state representation in relation to the first reusable work primitive; capture, by the at least one sensor, first sensor data at a first time; determine, by the at least one processor, a first state representation for the first time, based on the first sensor data; apply, by the at least one processor, the first percept to the first state representation to determine whether the first metric is satisfied.

The processor-executable instructions may further cause the robot system to: if the first metric is satisfied, output an indication of metric satisfaction. The processor-executable instructions may further cause the robot system to: if the first metric is not satisfied, output an indication of metric non-satisfaction.

The processor-executable instructions may further cause the robot system to, prior to the first time: capture, by the at least one sensor, second sensor data at a second time before the first time; determine, by the at least one processor, a goal state based on the second sensor data; select, by the at least one processor, the first percept and the associated first reusable work primitive by identifying the first metric as indicative of whether the robot system is in the goal state; and perform the first reusable work primitive to attempt to transition the robot system towards the goal state.

The processor-executable instructions may further cause the robot system to: determine, by the at least one processor, a goal state; select, by the at least one processor, the first percept and the associated first reusable work primitive by identifying the first metric as indicative of whether the robot system is in the goal state; if the first state representation satisfies the first metric, determine that the robot system is in the goal state; and if the first state representation does not satisfy the first metric, perform the first reusable work primitive to attempt to transition the robot system towards the goal state.

The first percept may be a Boolean function which returns either true or false.

The first metric may indicate a success state representation, and the first metric may be satisfied if the first state representation matches the success state representation.

The first metric may indicate at least one failure condition, and the first metric may be satisfied if the first state representation does not fulfill any of the at least one failure condition.

The processor-executable instructions which cause the robot system to access a first reusable work primitive from a library of reusable work primitives may cause the robot system to: access a plurality of reusable work primitives from the library of reusable work primitives, including the first reusable work primitive; the processor-executable instructions which cause the robot system to access the first percept may cause the robot system to: access a plurality of percepts including the first percept, each percept of the plurality of percepts associated with a respective reusable work primitive of the plurality of reusable work primitives, and each percept may comprise a respective metric for evaluating a respective state representation in relation to the respective reusable work primitive; the processor-executable instructions which cause the robot system to apply the first percept to the first state representation may cause the robot system to, for each percept in the plurality of percepts: apply the respective percept to least one respective aspect of the first state representation to determine whether the respective metric is satisfied; the processor-executable instructions may further cause the robot system to determine whether the first state representation satisfies a combined metric represented by the plurality of percepts, based on whether the respective metrics are satisfied. The processor-executable instructions which cause the robot system to determine whether the first state representation satisfies the combined metric may cause the robot system to: determine that the first state representation satisfies the combined metric if each respective aspect of the first state representation satisfies the respective metric of the respective percept applied to the respective aspect of the first state representation; and determine that the first state representation does not satisfy the combined metric if at least one respective aspect of the first state representation does not satisfy the respective metric of the respective percept applied to the respective aspect of the first state representation. The processor-executable instructions which cause the robot system to apply the first percept to the first state representation may further cause the robot system to, for each percept in the plurality of percepts: if the at least one respective aspect of the first state representation satisfies the respective metric, output an indication of metric satisfaction; and if the at least one respective aspect of the first state representation does not satisfy the respective metric, output an indication of metric non-satisfaction; and the processor-executable instructions which cause the robot system to determine whether the first state representation satisfies a combined metric represented by the plurality of percepts may cause the at least one processor to determine whether the first state representation satisfies the combined metric based on respective indications of metric satisfaction or metric non-satisfaction for each percept. The processor-executable instructions which cause the robot system to determine whether the first state representation satisfies the combined metric may cause the robot system to: evaluate a Boolean logic function which takes the indications of metric satisfaction or metric non-satisfaction for each respective aspect of the first state representation as input.

The at least one sensor may comprise at least one environment sensor carried by the robot body; the processor-executable instructions which cause the at least one sensor to capture first sensor data may cause the at least one environment sensor to capture first environment data representing an environment of the robot body at the first time; and the processor executable instructions which cause the at least one processor to determine a first state representation based on the first sensor data may cause the at least one processor to: determine the first state representation as a state of the environment of the robot body based on the first environment data.

The at least one sensor may comprise at least one robot body sensor carried by the robot body; the processor-executable instructions which cause the at least one sensor to capture first sensor data may cause the at least one robot body sensor to capture first robot body data representing a configuration of the robot body at the first time; and the processor executable instructions which cause the at least one processor to determine a first state representation based on the first sensor data may cause the at least one processor to: determine the first state representation as a configuration of the robot body based on the first robot body data.

The at least one sensor may comprise at least one robot body sensor carried by the robot body and at least one environment sensor carried by the robot body; the processor-executable instructions which cause the at least one sensor to capture first sensor data may cause the at least one robot body sensor to capture first robot body data representing a configuration of the robot body at the first time and may cause the at least one environment sensor to capture first environment data representing an environment of the robot body at the first time; and the processor-executable instructions which cause the at least one processor to determine a first state representation based on the first sensor data may cause the at least one processor to: determine the first state representation as a state of the environment of the robot body and a configuration of the robot body in the environment, based on the first environment data and the first robot body data.

The processor-executable instructions may further cause the robot system to: capture, by the at least one sensor, second sensor data at a second time subsequent the first time; determine, by the at least one processor, a second state representation for the second time, based on the second sensor data; apply, by the at least one processor, the first percept to the second state representation to determine whether the first metric is satisfied.

The at least one non-transitory processor-readable storage medium may further store the library of reusable work primitives. The at least one non-transitory processor-readable storage medium may further stores a library of percepts including the first percept.

The robot body may carry the at least one sensor and the robot controller. The processor-executable instructions which cause the robot system to access the first reusable work primitive and the processor-executable instructions which cause the robot system to access the first percept may cause the robot system to: receive data including the first reusable work primitive and the first percept from a device remote from the robot body. The processor-executable instructions which cause the robot system to access the first reusable work primitive and the processor-executable instructions which cause the robot system to access the first percept may cause the robot system to: retrieve the first reusable work primitive and the first percept from the at least one non-transitory processor-readable storage medium of the robot controller.

The robot system may further comprise a remote device remote from the robot body which includes the robot controller. The at least one sensor may be carried by the robot body; the robot system may further comprise at least one communication interface which communicatively couples the robot body and the remote device; and the processor-executable instructions may further cause the robot system to transmit, by the at least one communication interface, the first sensor data from the robot body to the remote device.

According to another broad aspect, the present disclosure describes a robot system comprising: a robot body; at least one sensor; a robot controller which includes at least one processor and at least one non-transitory processor-readable storage medium communicatively coupled to the at least one processor, the at least one processor-readable storage medium storing processor-executable instructions which when executed by the at least one processor cause the robot system to: identify, by the at least one processor, a workflow to complete a work objective, the workflow comprising a plurality of reusable work primitives available in a library of reusable work primitives; access each reusable work primitive in the plurality of reusable work primitives; access a plurality of percepts, each percept in the plurality of percepts associated with a respective reusable work primitive in the plurality of reusable work primitives, each percept in the plurality of percepts comprising a respective metric for evaluating a state representation in relation to the respective reusable work primitive; and perform the workflow, wherein for each reusable work primitive in the plurality of reusable work primitives: the processor-executable instructions further cause the robot system to capture, by the at least one sensor, respective sensor data at a respective time; the processor-executable instructions further cause the robot system to determine, by the at least one processor, a respective state representation for the respective time, based on the respective sensor data; and the processor-executable instructions further cause the robot system to apply the respective percept to the respective state representation to determine whether the respective metric is satisfied.

The processor-executable instructions may further cause the robot system to, for each reusable work primitive in the plurality of reusable work primitives, prior to each respective time: determine, by the at least one processor, a respective goal state for the respective reusable work primitive based on the workflow; and perform the respective reusable work primitive to attempt to transition the robot system towards the respective goal state as part of performing the workflow.

The processor-executable instructions may further cause the robot system to, for each reusable work primitive in the plurality of reusable work primitives: determine, by the at least one processor, a respective goal state; if the respective state representation satisfies the respective metric, determine that the robot system is in the respective goal state; and if the respective state representation does not satisfy the respective metric, perform the respective reusable work primitive to attempt to transition the robot system towards the respective goal state as part of performing the workflow.

Each percept may be a Boolean function which returns either true or false.

The processor-executable instructions may further cause the robot system to determine whether a combined metric is satisfied based on whether the respective metrics are satisfied; and the combined metric is represented by the plurality of percepts and is for evaluating whether a combined state representation in relation to the work objective is satisfied. The processor-executable instructions which cause the robot system to determine whether the combined metric is satisfied may cause the robot system to: determine that the combined metric is satisfied if each respective state representation satisfies the respective metric of the respective percept applied to the respective state representation; and determine that the combined metric is not satisfied if at least one respective state representation does not satisfy the respective metric of the respective percept applied to the respective state representation. The processor-executable instructions which cause the robot system to, for each reusable work primitive in the plurality of reusable work primitives, apply the respective percept to the respective state representation may further cause the robot system to, for each reusable work primitive in the plurality of reusable work primitives: if the respective state representation satisfies the respective metric, output an indication of metric satisfaction for the respective percept; and if the respective state representation does not satisfy the respective metric, output an indication of metric non-satisfaction for the respective percept; and the processor-executable instructions which cause the robot system to determine whether the combined metric is satisfied may cause the robot system to: determine whether the combined metric is satisfied based on respective indications of metric satisfaction or metric non-satisfaction for each percept. The processor-executable instructions which cause the robot system to determine whether the combined metric is satisfied may cause the robot system to: evaluate a Boolean logic function which takes the indications of metric satisfaction or metric non-satisfaction for each respective percept as input.

The processor-executable instructions may further cause the robot system to: capture, by the at least one sensor, additional sensor data subsequent the respective times; determine, by the at least one processor, an additional state representation based on the additional sensor data; apply, by the at least one processor, a final percept of the plurality of percepts to the additional state representation to determine whether the respective metric for the final percept is satisfied.

According to yet another broad aspect, the present disclosure describes a method for operating a robot system including a robot body, a robot controller, and at least one sensor, the method comprising: accessing, by the robot controller, a first reusable work primitive from a library of reusable work primitives; accessing, by the robot controller, a first percept associated with the first reusable work primitive, wherein the first percept comprises a first metric for evaluating a state representation in relation to the first reusable work primitive; capturing, by the at least one sensor, first sensor data at a first time; determining, by at least one processor of the robot controller, a first state representation for the first time, based on the first sensor data; applying, by the at least one processor, the first percept to the first state representation to determine whether the first metric is satisfied.

The method may further comprise: if the first metric is satisfied, outputting an indication of metric satisfaction. The method may further comprise: if the first metric is not satisfied, outputting an indication of metric non-satisfaction.

The method may further comprise, prior to the first time: capturing, by the at least one sensor, second sensor data at a second time before the first time; determining, by the at least one processor, a goal state based on the second sensor data; selecting, by the at least one processor, the first percept and the associated first reusable work primitive by identifying the first metric as indicative of whether the robot system is in the goal state; and performing the first reusable work primitive to attempt to transition the robot system towards the goal state.

The method may further comprise: determining, by the at least one processor, a goal state; selecting, by the at least one processor, the first percept and the associated first reusable work primitive by identifying the first metric as indicative of whether the robot system is in the goal state; if the first state representation satisfies the first metric, determining that the robot system is in the goal state; and if the first state representation does not satisfy the first metric, performing the first reusable work primitive to attempt to transition the robot system towards the goal state.

The first percept may be a Boolean function which returns either true or false.

The first metric may indicate a success state representation, and the first metric may be satisfied if the first state representation matches the success state representation.

The first metric may indicate at least one failure condition, and the first metric may be satisfied if the first state representation does not fulfill any of the at least one failure condition.

Accessing a first reusable work primitive from a library of reusable work primitives may comprise: accessing a plurality of reusable work primitives from the library of reusable work primitives, including the first reusable work primitive; accessing the first percept may comprise: accessing a plurality of percepts including the first percept, each percept of the plurality of percepts associated with a respective reusable work primitive of the plurality of reusable work primitives, wherein each percept may comprise a respective metric for evaluating a respective state representation in relation to the respective reusable work primitive; applying the first percept to the first state representation may comprise, for each percept in the plurality of percepts: applying the respective percept to at least one respective aspect of the first state representation to determine whether the respective metric is satisfied; the method may further comprise determining, by the at least one processor, whether the first state representation satisfies a combined metric represented by the plurality of percepts, based on whether the respective metrics are satisfied. Determining whether the first state representation satisfies the combined metric may comprise: determining that the first state representation satisfies the combined metric if each respective aspect of the first state representation satisfies the respective metric of the respective percept applied to the respective aspect of the first state representation; and determining that the first state representation does not satisfy the combined metric if at least one respective aspect of the first state representation does not satisfy the respective metric of the respective percept applied to the respective aspect of the first state representation. Applying the first percept to the first state representation may comprise, for each percept in the plurality of percepts: if the at least one respective aspect of the first state representation satisfies the respective metric, outputting an indication of metric satisfaction; and if the at least one respective aspect of the first state representation does not satisfy the respective metric, outputting an indication of metric non-satisfaction; and determining whether the first state representation satisfies a combined metric represented by the plurality of percepts may comprise determining whether the first state representation satisfies the combined metric based on respective indications of metric satisfaction or metric non-satisfaction for each percept. Determining whether the first state representation satisfies the combined metric may comprise: evaluating a Boolean logic function which takes the indications of metric satisfaction or metric non-satisfaction for each respective aspect of the first state representation as input.

The at least one sensor may comprise at least one environment sensor carried by the robot body; capturing first sensor data may comprise capturing first environment data representing an environment of the robot body at the first time; and determining a first state representation based on the first sensor data may comprise: determining the first state representation as a state of the environment of the robot body based on the first environment data.

The at least one sensor may comprise at least one robot body sensor carried by the robot body; capturing first sensor data may comprise capturing first robot body data representing a configuration of the robot body at the first time; and determining a first state representation based on the first sensor data may comprise: determining the first state representation as a configuration of the robot body based on the first robot body data.

The at least one sensor may comprise at least one robot body sensor carried by the robot body and at least one environment sensor carried by the robot body; capturing first sensor data may comprise capturing, by the at least one robot body sensor, first robot body data representing a configuration of the robot body at the first time and may comprise capturing, by the at least one environment sensor, first environment data representing an environment of the robot body at the first time; and determining a first state representation based on the first sensor data may comprise: determining the first state representation as a state of the environment of the robot body and a configuration of the robot body in the environment, based on the first environment data and the first robot body data.

The method may further comprise: capturing, by the at least one sensor, second sensor data at a second time subsequent the first time; determining, by the at least one processor, a second state representation for the second time, based on the second sensor data; applying, by the at least one processor, the first percept to the second state representation to determine whether the first metric is satisfied.

At least one non-transitory processor-readable storage medium of the robot controller may store the library of reusable work primitives.

At least one non-transitory processor-readable storage medium of the robot controller may store a library of percepts including the first percept.

The robot body may carry the at least one sensor and the robot controller; and accessing the first reusable work primitive and accessing the first percept may comprise: receiving data including the first reusable work primitive and the first percept from a device remote from the robot body.

The robot body may carry the at least one sensor and the robot controller; and accessing the first reusable work primitive and accessing the first percept may comprise: retrieving the first reusable work primitive and the first percept from at least one non-transitory processor-readable storage medium of the robot controller.

The at least one sensor may be carried by the robot body; the robot controller may be positioned at a remote device remote from the robot body; and the method may further comprise transmitting, by at least one communication interface which communicatively couples the robot body and the remote device, the first sensor data from the robot body to the remote device.

According to yet another broad aspect, the present disclosure describes a method for operating a robot system including a robot body, a robot controller, and at least one sensor, the method comprising: identifying, by the at least one processor, a workflow to complete a work objective, the workflow comprising a plurality of reusable work primitives available in a library of reusable work primitives; accessing, by the robot controller, each reusable work primitive in the plurality of reusable work primitives; accessing, by the robot controller, a plurality of percepts, each percept in the plurality of percepts associated with a respective reusable work primitive in the plurality of reusable work primitives, each percept in the plurality of percepts comprising a respective metric for evaluating a state representation in relation to the respective reusable work primitive; and performing the workflow, wherein for each reusable work primitive in the plurality of reusable work primitives, the method further comprises: capturing, by the at least one sensor, respective sensor data at a respective time; determining, by the at least one processor, the respective state representation of for the respective time, based on the respective sensor data; and applying the respective percept to the respective state representation to determine whether the respective metric is satisfied.

The method may further comprise, for each reusable work primitive in the plurality of reusable work primitives, prior to each respective time: determining, by the at least one processor, a respective goal state for the respective reusable work primitive based on the workflow; and performing the respective reusable work primitive to attempt to transition the robot system towards the respective goal state as part of performing the workflow.

The method may further comprise, for each reusable work primitive in the plurality of reusable work primitives: determining, by the at least one processor, a respective goal state; if the respective state representation satisfies the respective metric, determining that the robot system is in the respective goal state; and if the respective state representation does not satisfy the respective metric, performing the respective reusable work primitive to attempt to transition the robot system towards the respective goal state as part of performing the workflow.

Each percept may be a Boolean function which returns either true or false.

The method may further comprise determining whether a combined metric is satisfied based on whether the respective metrics are satisfied; and the combined metric may be represented by the plurality of percepts and may be for evaluating whether a combined state representation in relation to the work objective is satisfied. Determining whether the combined metric is satisfied may comprise: determining that the combined metric is satisfied if each respective state representation satisfies the respective metric of the respective percept applied to the respective state representation; and determining that the combined metric is not satisfied if at least one respective state representation does not satisfy the respective metric of the respective percept applied to the respective state representation. For each reusable work primitive in the plurality of reusable work primitives, applying the respective percept to the respective state representation may comprise, for each reusable work primitive in the plurality of reusable work primitives: if the respective state representation satisfies the respective metric, outputting an indication of metric satisfaction for the respective percept; and if the respective state representation does not satisfy the respective metric, outputting an indication of metric non-satisfaction for the respective percept; and determining whether the combined metric is satisfied may comprise: determining whether the combined metric is satisfied based on respective indications of metric satisfaction or metric non-satisfaction for each percept. Determining whether the combined metric is satisfied may comprise: evaluating a Boolean logic function which takes the indications of metric satisfaction or metric non-satisfaction for each respective percept as input.

The method may further comprise: capturing, by the at least one sensor, additional sensor data subsequent the respective times; determining, by the at least one processor, an additional state representation based on the additional sensor data; applying, by the at least one processor, a final percept of the plurality of percepts to the additional state representation to determine whether the respective metric for the final percept is satisfied.

According to yet another broad aspect, the present disclosure describes a robot control module comprising at least one non-transitory processor-readable storage medium storing processor-executable instructions or data that, when executed by at least one processor of a processor-based system, cause the processor-based system to: access a first reusable work primitive from a library of reusable work primitives; access a first percept associated with the first reusable work primitive, wherein the first percept comprises a first metric for evaluating a state representation in relation to the first reusable work primitive; capture, by at least one sensor carried by a robot body of the processor-based system, first sensor data at a first time; determine, by the at least one processor, a first state representation for the first time, based on the first sensor data; apply, by the at least one processor, the first percept to the first state representation to determine whether the first metric is satisfied.

The processor-executable instructions or data may further cause the processor-based system to: if the first metric is satisfied, output an indication of metric satisfaction.

The processor-executable instructions or data may further cause the processor-based system to: if the first metric is not satisfied, output an indication of metric non-satisfaction.

The processor-executable instructions or data may further cause the processor-based system to, prior to the first time: capture, by the at least one sensor, second sensor data at a second time before the first time; determine, by the at least one processor, a goal state based on the second sensor data; select, by the at least one processor, the first percept and the associated first reusable work primitive by identifying the first metric as indicative of whether the processor-based system is in the goal state; and perform the first reusable work primitive to attempt to transition the processor-based system towards the goal state.

The processor-executable instructions or data may further cause the processor-based system to: determine, by the at least one processor, a goal state; select, by the at least one processor, the first percept and the associated first reusable work primitive by identifying the first metric as indicative of whether the processor-based system is in the goal state; if the first state representation satisfies the first metric, determine that the processor-based system is in the goal state; and if the first state representation does not satisfy the first metric, perform the first reusable work primitive to attempt to transition the processor-based system towards the goal state.

The first percept may be a Boolean function which returns either true or false.

The first metric may indicate a success state representation, and the first metric may be satisfied if the first state representation matches the success state representation.

The first metric may indicate at least one failure condition, and the first metric may be satisfied if the first state representation does not fulfill any of the at least one failure condition.

The processor-executable instructions or data which cause the processor-based system to access a first reusable work primitive from a library of reusable work primitives may cause the processor-based system to: access a plurality of reusable work primitives from the library of reusable work primitives, including the first reusable work primitive; the processor-executable instructions or data which cause the processor-based system to access the first percept may cause the processor-based system to: access a plurality of percepts including the first percept, each percept of the plurality of percepts associated with a respective reusable work primitive of the plurality of reusable work primitives, and each percept may comprise a respective metric for evaluating a respective state representation in relation to the respective reusable work primitive; the processor-executable instructions or data which cause the processor-based system to apply the first percept to the first state representation may cause the processor-based system to, for each percept in the plurality of percepts: apply the respective percept to least one respective aspect of the first state representation to determine whether the respective metric is satisfied; the processor-executable instructions or data may further cause the processor-based system to determine whether the first state representation satisfies a combined metric represented by the plurality of percepts, based on whether the respective metrics are satisfied. The processor-executable instructions or data which cause the processor-based system to determine whether the first state representation satisfies the combined metric may cause the processor-based system to: determine that the first state representation satisfies the combined metric if each respective aspect of the first state representation satisfies the respective metric of the respective percept applied to the respective aspect of the first state representation; and determine that the first state representation does not satisfy the combined metric if at least one respective aspect of the first state representation does not satisfy the respective metric of the respective percept applied to the respective aspect of the first state representation. The processor-executable instructions or data which cause the processor-based system to apply the first percept to the first state representation may further cause the processor-based system to, for each percept in the plurality of percepts: if the at least one respective aspect of the first state representation satisfies the respective metric, output an indication of metric satisfaction; and if the at least one respective aspect of the first state representation does not satisfy the respective metric, output an indication of metric non-satisfaction; and the processor-executable instructions or data which cause the processor-based system to determine whether the first state representation satisfies a combined metric represented by the plurality of percepts may cause the at least one processor to determine whether the first state representation satisfies the combined metric based on respective indications of metric satisfaction or metric non-satisfaction for each percept. The processor-executable instructions or data which cause the processor-based system to determine whether the first state representation satisfies the combined metric may cause the processor-based system to: evaluate a Boolean logic function which takes the indications of metric satisfaction or metric non-satisfaction for each respective aspect of the first state representation as input.

The at least one sensor may comprise at least one environment sensor carried by the robot body; the processor-executable instructions or data which cause the at least one sensor to capture first sensor data may cause the at least one environment sensor to capture first environment data representing an environment of the robot body at the first time; and the processor-executable instructions or data which cause the at least one processor to determine a first state representation based on the first sensor data may cause the at least one processor to: determine the first state representation as a state of the environment of the robot body based on the first environment data.

The at least one sensor may comprise at least one robot body sensor carried by the robot body; the processor-executable instructions or data which cause the at least one sensor to capture first sensor data may cause the at least one robot body sensor to capture first robot body data representing a configuration of the robot body at the first time; and the processor executable instructions or data which cause the at least one processor to determine a first state representation based on the first sensor data may cause the at least one processor to: determine the first state representation as a configuration of the robot body based on the first robot body data.

The at least one sensor may comprise at least one robot body sensor carried by the robot body and at least one environment sensor carried by the robot body; the processor-executable instructions or data which cause the at least one sensor to capture first sensor data may cause the at least one robot body sensor to capture first robot body data representing a configuration of the robot body at the first time and may cause the at least one environment sensor to capture first environment data representing an environment of the robot body at the first time; and the processor-executable instructions or data which cause the at least one processor to determine a first state representation based on the first sensor data may cause the at least one processor to: determine the first state representation as a state of the environment of the robot body and a configuration of the robot body in the environment, based on the first environment data and the first robot body data.

The processor-executable instructions or data may further cause the processor-based system to: capture, by the at least one sensor, second sensor data at a second time subsequent the first time; determine, by the at least one processor, a second state representation for the second time, based on the second sensor data; and apply, by the at least one processor, the first percept to the second state representation to determine whether the first metric is satisfied.

The at least one non-transitory processor-readable storage medium may further store the library of reusable work primitives.

The at least one non-transitory processor-readable storage medium may further store a library of percepts including the first percept.

The robot body may carry the at least one sensor and the at least one processor. The processor-executable instructions or data which cause the processor-based system to access the first reusable work primitive and the processor-executable instructions or data which cause the processor-based system to access the first percept may cause the processor-based system to: receive data including the first reusable work primitive and the first percept from a device remote from the robot body. The processor-executable instructions or data which cause the processor-based system to access the first reusable work primitive and the processor-executable instructions or data which cause the processor-based system to access the first percept may cause the processor-based system to: retrieve the first reusable work primitive and the first percept from the at least one non-transitory processor-readable storage medium of the robot controller.

The robot control module may further comprise a remote device remote from the robot body which includes the at least one non-transitory processor-readable storage medium and the at least one processor. The processor-based system may include at least one communication interface which communicatively couples the robot body and the remote device; and the processor-executable instructions or data may further cause the processor-based system to transmit, by the at least one communication interface, the first sensor data from the robot body to the remote device.

According to yet another broad aspect, the present disclosure describes a robot control module comprising at least one non-transitory processor-readable storage medium storing processor-executable instructions or data that, when executed by at least one processor of a processor-based system, cause the processor-based system to: identify, by the at least one processor, a workflow to complete a work objective, the workflow comprising a plurality of reusable work primitives available in a library of reusable work primitives; access each reusable work primitive in the plurality of reusable work primitives; access a plurality of percepts, each percept in the plurality of percepts associated with a respective reusable work primitive in the plurality of reusable work primitives, each percept in the plurality of percepts comprising a respective metric for evaluating a state representation in relation to the respective reusable work primitive; and perform the workflow, wherein for each reusable work primitive in the plurality of reusable work primitives: the processor-executable instructions or data further cause the processor-based system to capture, by at least one sensor carried by a robot body of the processor-based system, respective sensor data at a respective time; the processor-executable instructions or data further cause the processor-based system to determine, by the at least one processor, the respective state representation for the respective time, based on the respective sensor data; and the processor-executable instructions or data further cause the processor-based system to apply the respective percept to the respective state representation to determine whether the respective metric is satisfied.

The processor-executable instructions or data may further cause the processor-based system to, for each reusable work primitive in the plurality of reusable work primitives, prior to each respective time: determine, by the at least one processor, a respective goal state for the respective reusable work primitive based on the workflow; and perform the respective reusable work primitive to attempt to transition the processor-based system towards the respective goal state as part of performing the workflow.

The processor-executable instructions or data may further cause the processor-based system to, for each reusable work primitive in the plurality of reusable work primitives: determine, by the at least one processor, a respective goal state; if the respective state representation satisfies the respective metric, determine that the processor-based system is in the respective goal state; and if the respective state representation does not satisfy the respective metric, perform the respective reusable work primitive to attempt to transition the processor-based system towards the respective goal state as part of performing the workflow.

Each percept may be a Boolean function which returns either true or false.

The processor-executable instructions or data may further cause the processor-based system to determine whether a combined metric is satisfied based on whether the respective metrics are satisfied; and the combined metric may be represented by the plurality of percepts and for evaluating whether a combined state representation in relation to the work objective is satisfied. The processor-executable instructions or data which cause the processor-based system to determine whether the combined metric is satisfied may cause the processor-based system to: determine that the combined metric is satisfied if each respective state representation satisfies the respective metric of the respective percept applied to the respective state representation; and determine that the combined metric is not satisfied if at least one respective state representation does not satisfy the respective metric of the respective percept applied to the respective state representation. The processor-executable instructions or data which cause the processor-based system to, for each reusable work primitive in the plurality of reusable work primitives, apply the respective percept to the respective state representation may further cause the processor-based system to, for each reusable work primitive in the plurality of reusable work primitives: if the respective state representation satisfies the respective metric, output an indication of metric satisfaction for the respective percept; and if the respective state representation does not satisfy the respective metric, output an indication of metric non-satisfaction for the respective percept; and the processor-executable instructions or data which cause the processor-based system to determine whether the combined metric is satisfied may cause the processor-based system to: determine whether the combined metric is satisfied based on respective indications of metric satisfaction or metric non-satisfaction for each percept. The processor-executable instructions or data which cause the processor-based system to determine whether the combined metric is satisfied may cause the processor-based system to: evaluate a Boolean logic function which takes the indications of metric satisfaction or metric non-satisfaction for each respective percept as input.

The processor-executable instructions or data may further cause the processor-based system to: capture, by the at least one sensor, additional sensor data subsequent the respective times; determine, by the at least one processor, an additional state representation based on the additional sensor data; and apply, by the at least one processor, a final percept of the plurality of percepts to the additional state representation to determine whether the respective metric for the final percept is satisfied.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is an illustrative diagram of an exemplary robot system comprising various features and components described throughout the present robots, systems, methods, and computer program products.

FIG. 2 is a flow diagram showing an exemplary method of operation of a robot in accordance with the present robots, systems, methods, and computer program products.

FIG. 3 illustrates a table showing several exemplary reusable work primitives and associated percepts in accordance with the present robots, systems, methods, and computer program products.

FIG. 4 is a flow diagram showing yet another exemplary method of operation of a robot system in accordance with the present robots, systems, methods, and computer program products.

FIG. 5 is a flow diagram showing yet another exemplary method of operation of a robot system in accordance with the present robots, systems, methods, and computer program products.

FIG. 6 is a flow diagram showing yet another exemplary method of operation of a robot system in accordance with the present robots, systems, methods, and computer program products.

FIG. 7 is a flow diagram showing yet another exemplary method of operation of a robot system in accordance with the present robots, systems, methods, and computer program products.

FIG. 8 is a flow diagram showing yet another exemplary method of operation of a robot system in accordance with the present robots, systems, methods, and computer program products.

FIG. 9 is a flow diagram showing yet another exemplary method of operation of a robot system in accordance with the present robots, systems, methods, and computer program products.

FIG. 10 is a flow diagram showing yet another exemplary method of operation of a robot system in accordance with the present robots, systems, methods, and computer program products.

FIG. 11 is a flow diagram showing yet another exemplary method of operation of a robot system in accordance with the present robots, systems, methods, and computer program products.

### DETAILED DESCRIPTION

The following description sets forth specific details in order to illustrate and provide an understanding of the various implementations and embodiments of the present robots, systems, computer program products, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present robots, systems, computer program products, and methods.

A general-purpose robot is able to complete multiple different work objectives. As used throughout this specification and the appended claims, the term “work objective” refers to a particular task, job, assignment, or application that has a specified goal and a determinable outcome, often (though not necessarily) in the furtherance of some economically valuable work. Work objectives exist in many aspects of business, research and development, commercial endeavors, and personal activities. Exemplary work objectives include, without limitation: cleaning a location (e.g., a bathroom) or an object (e.g., a bathroom mirror), preparing a meal, loading/unloading a storage container (e.g., a truck), taking inventory, collecting one or more sample(s), making one or more measurement(s), building or assembling an object, destroying or disassembling an object, delivering an item, harvesting objects and/or data, and so on. The various implementations described herein provide robots, systems, computer program products, and methods for operating a robot system, to at least semi-autonomously complete tasks or work objectives.

In accordance with the present robots, systems, computer program products, and methods, a work objective can be deconstructed or broken down into a “workflow” comprising a set or plurality of “work primitives”, where successful completion of the work objective involves performing each work primitive in the workflow. Depending on the specific implementation, completion of a work objective may be achieved by (i.e., a workflow may comprise): i) performing a corresponding set of work primitives sequentially or in series; ii) performing a corresponding set of work primitives in parallel; or iii) performing a corresponding set of work primitives in any combination of in series and in parallel (e.g., sequentially with overlap) as suits the work objective and/or the robot performing the work objective. Thus, in some implementations work primitives may be construed as lower-level activities, steps, or sub-tasks that are performed or executed as a workflow in order to complete a higher-level work objective.

Advantageously, and in accordance with the present robots, systems, computer program products, and methods, a catalog of “reusable” work primitives may be defined. A work primitive is reusable if it may be generically invoked, performed, employed, or applied in the completion of multiple different work objectives. For example, a reusable work primitive is one that is common to the respective workflows of multiple different work objectives. In some implementations, a reusable work primitive may include at least one variable that is defined upon or prior to invocation of the work primitive. For example, “pick up *object*” may be a reusable work primitive where the process of “picking up” may be generically performed at least semi-autonomously in furtherance of multiple different work objectives and the *object* to be picked up may be defined based on the specific work objective being pursued.

As stated previously, the various implementations described herein provide robots, systems, computer program products, and methods where a robot is enabled to at least semi-autonomously perform tasks or complete work objectives. Unless the specific context requires otherwise, the term “autonomously” is used throughout this specification and the appended claims to mean “without control by another party” and the term “semi-autonomously” is used to mean “at least partially autonomously.” In other words, throughout this specification and the appended claims, the term “semi-autonomously” means “with limited control by another party” unless the specific context requires otherwise. An example of a semi-autonomous robot is one that can independently and/or automatically execute and control some of its own low-level functions, such as its mobility and gripping functions, but relies on some external control for high-level instructions such as what to do and/or how to do it.

In accordance with the present robots, systems, computer program products, and methods, a catalog of reusable work primitives may be defined, identified, developed, or constructed such that any given work objective across multiple different work objectives may be completed by executing a corresponding workflow comprising a particular combination and/or permutation of reusable work primitives selected from the catalog of reusable work primitives. The various implementations described herein also provide robots, systems, computer program products, and methods where a robot system is trained to autonomously perform reusable work primitives in libraries of reusable work primitives. Once such a catalog of reusable work primitives has been established, one or more robot(s) may be trained to autonomously or automatically perform each individual reusable work primitive in the catalog of reusable work primitives without necessarily including the context of: i) a particular workflow of which the particular reusable work primitive being trained is a part, and/or ii) any other reusable work primitive that may, in a particular workflow, precede or succeed the particular reusable work primitive being trained. In this way, a semi-autonomous robot may be operative to autonomously or automatically perform each individual reusable work primitive in a catalog of reusable work primitives and only require instruction, direction, or guidance from another party (e.g., from an operator, user, or pilot) when it comes to deciding which reusable work primitive(s) to perform and/or in what order. In other words, an operator, user, or pilot may provide a workflow consisting of reusable work primitives to a semi-autonomous robot system and the semi-autonomous robot system may autonomously or automatically execute the reusable work primitives according to the workflow to complete a work objective. For example, a semi-autonomous humanoid robot may be operative to autonomously look left when directed to look left, autonomously open its right end effector when directed to open its right end effector, and so on, without relying upon detailed low-level control of such functions by a third party. Such a semi-autonomous humanoid robot may autonomously complete a work objective once given instructions regarding a workflow detailing which reusable work primitives it must perform, and in what order, in order to complete the work objective. Furthermore, in accordance with the present robots, systems, methods, and computer program products, a robot system may operate fully autonomously if it is trained or otherwise configured to analyze a work objective and independently define a corresponding workflow itself by deconstructing the work objective into a set of reusable work primitives from a library of reusable work primitives that the robot system is operative to autonomously perform.

In the context of a robot system, reusable work primitives may correspond to basic low-level functions that the robot system is operable to (e.g., autonomously or automatically) perform and that the robot system may call upon or execute in order to achieve something. Examples of reusable work primitives for a humanoid robot include, without limitation: look up, look down, look left, look right, move right arm, move left arm, close right end effector, open right end effector, close left end effector, open left end effector, move forward, turn left, turn right, move backwards, and so on; however, a person of skill in the art will appreciate that: i) the foregoing list of exemplary reusable work primitives for a humanoid robot is by no means exhaustive; ii) the present robots, systems, computer program products, and methods are not limited in any way to robots having a humanoid form factor; and iii) the complete composition of any library of reusable work primitives depends on the design and functions of the specific robot for which the library of reusable work primitives is constructed.

A robot system may be operative to perform any number of high-level functions based at least in part on its hardware and software configurations. For example, a robot with legs or wheels may be operative to move, a robot with a gripper may be operative to pick things up, and a robot with legs and a gripper may be operative to displace objects. The performance of any such high-level function generally requires the controlled execution of multiple low-level functions. For example, a mobile robot must exercise control of a number of different lower-level functions in order to controllably move, including control of mobility actuators (e.g., driving its legs or wheels) that govern functional parameters like speed, trajectory, balance, and so on. In accordance with the present robots, systems, computer program products, and methods, the high-level functions that a robot is operative to perform are deconstructed or broken down into a set of basic components or constituents, referred to throughout this specification and the appended claims as “work primitives”. Unless the specific context requires otherwise, work primitives may be construed as the building blocks of which higher-level robot functions are constructed.

In some implementations training a robot system to autonomously perform a reusable work primitive may be completed in a real-world environment or a simulated environment. Once a robot has been trained to autonomously perform a catalog of reusable work primitives, tele-operation of the robot by a remote pilot may be abstracted to the level of reusable work primitives; i.e., a remote operator or pilot that controls the robot through a tele-operation system may do so by simply instructing the robot which reusable work primitive(s) to perform and, in some implementations, in what order to perform them, and the robot may have sufficient autonomy or automation (resulting from, for example, the training described above) to execute a complete work objective based on such limited control instruction from the pilot.

As described previously, “clean a bathroom mirror” is an illustrative example of a work objective that can be deconstructed into a set of work primitives to achieve a goal and for which the outcome is determinable. The goal in this case is a clean bathroom mirror, and an exemplary set of work primitives (or workflow) that completes the work objective is as follows:

| Work Primitive Index | Work Primitive |
|---|---|
| 1 | Locate cleaning solution |
| 2 | Grasp the cleaning solution |
| 3 | Locate mirror |
| 4 | Aim the cleaning solution at the mirror |
| 5 | Dispense the cleaning solution onto the mirror |
| 6 | Locate the cleaning cloth |
| 7 | Grasp the cleaning cloth |
| 8 | Pass the cleaning cloth over the entire surface |
| | of the mirror |
| 9 | Return to ready |

A person of skill in the art will appreciate that the exemplary workflow above, comprising nine work primitives, is used as an illustrative example of a workflow that may be deployed to complete the work objective of cleaning a bathroom mirror; however, in accordance with the present robots, systems, computer program products, and methods the precise definition and composition of each work primitive and the specific combination and/or permutation of work primitives selected/executed to complete a work objective (i.e., the specific construction of a workflow) may vary in different implementations. For example, in some implementations work primitives 3, 4, and 5 above (i.e., locate mirror, aim the cleaning solution at the mirror, and dispense the cleaning solution onto the mirror) may all be combined into one higher-level work primitive as “spray cleaning solution on the mirror” whereas in other implementations those same work primitives may be broken down into additional lower-level work primitives as, for example:
Locate the mirror
Identify the boundaries of the mirror
Aim the cleaning solution at a first location within the boundaries of the mirror
Squeeze the cleaning solution
Aim the cleaning solution at a second location within the boundaries of the mirror
Squeeze the cleaning solution
Etc.

Based on the above example and description, a person of skill in the art will appreciate that the granularity of work primitives may vary across different implementations of the present robots, systems, computer program products, and methods. Furthermore, in accordance with the present robots, systems, computer program products, and methods the work primitives are advantageously “reusable” in the sense that each work primitive may be employed, invoked, applied, or “reused” in the performance of more than one overall work objective. For example, while cleaning a bathroom mirror may involve the work primitive “grasp the cleaning solution,” other work objectives may also use the “grasp the cleaning solution” work primitive, such as for example “clean the toilet,” “clean the window,” and/or “clean the floor.” In some implementations, work primitives may be abstracted to become more generic. For example, “grasp the cleaning solution” may be abstracted to “grasp the spray bottle” or “grasp the *object1*” where the *object1* variable is defined as “*object1*=spray bottle”, and “locate the mirror” may be abstracted to “locate the object that needs to be sprayed” or simply “locate *object2*” where “*object2*=mirror”. In such cases, the “grasp the spray bottle” work primitive may be used in tasks that do not involve cleaning, such as “paint the wall” (where the spray bottle=spray paint), “style the hair” (where the spray bottle=hairspray), or “prepare the stir-fry meal” (where the spray bottle=cooking oil spray).

In order to train or evaluate performance of the present robots, systems, computer program products, and methods, and/or to monitor performance of the same, work primitives are associated with respective “percepts”. The term “percept” is derived from “perception”, and generally refers to a metric for evaluating a state representation in relation to a particular reusable work primitive associated with the percept. For the purpose of discussion in several exemplary implementations below, a particular percept is associated with a particular reusable work primitive, and the particular percept comprises a metric for evaluating a state representation in relation to the particular reusable work primitive. As examples, a particular percept may evaluate (or check) whether a particular work primitive has been completed, or whether a robot and/or its environment is in a state or configuration that corresponds to or is consistent with a particular work primitive having been completed, or whether a robot and/or its environment is in a state or configuration that is suitable for a particular work primitive to be completed.

In a first exemplary implementation, the particular metric corresponds to a success state for the reusable work primitive. That is, in this first implementation, the particular metric represents a desired state of a robot body or element of the robot body (including physical elements such as an actuatable member and/or logical elements such as a processor), after having successfully executed the particular reusable work primitive. Importantly, such a percept can be utilized to check the state of the robot body before or after actually attempting to execute the particular reusable work primitive, as discussed in more detail later.

In a second exemplary implementation, the particular metric corresponds to a representation of the robot body having failed to successfully execute the particular reusable work primitive. For example, the particular metric could include any number of state representations corresponding to failure states.

Percepts can be multimodal, representing a sensor fusion of different data streams. As an example, a percept “is_touching (OBJ_UID)” is for determining whether a robot end effector is touching an object identified by a unique identifier OBJ_UID for the object. In one way to achieve this, the percept when executed or applied can cause a robot controller to query an inner world model (i.e., the robot's internal simulation of its external environment) to see if the position of the end effector is within a radius of the object considered as touching. In another way to achieve this, processed visual data captured by an image sensor of the robot may show that a detection bounding box of the end effector is close to a detection bounding box of the object. In another way to achieve this, a pressure signal may be detected from a pressure or tactile sensor at a tip of the end effector used to touch the object. In an exemplary implementation, the percept can combine any (or all) of these examples (and/or any other appropriate detection dues) to arrive at a conclusion on whether the end effector is touching the object. These different modalities provide a “sensor fusion” type of function, combining any available types of data, such as proprioception, vision, haptic, and/or tactile data.

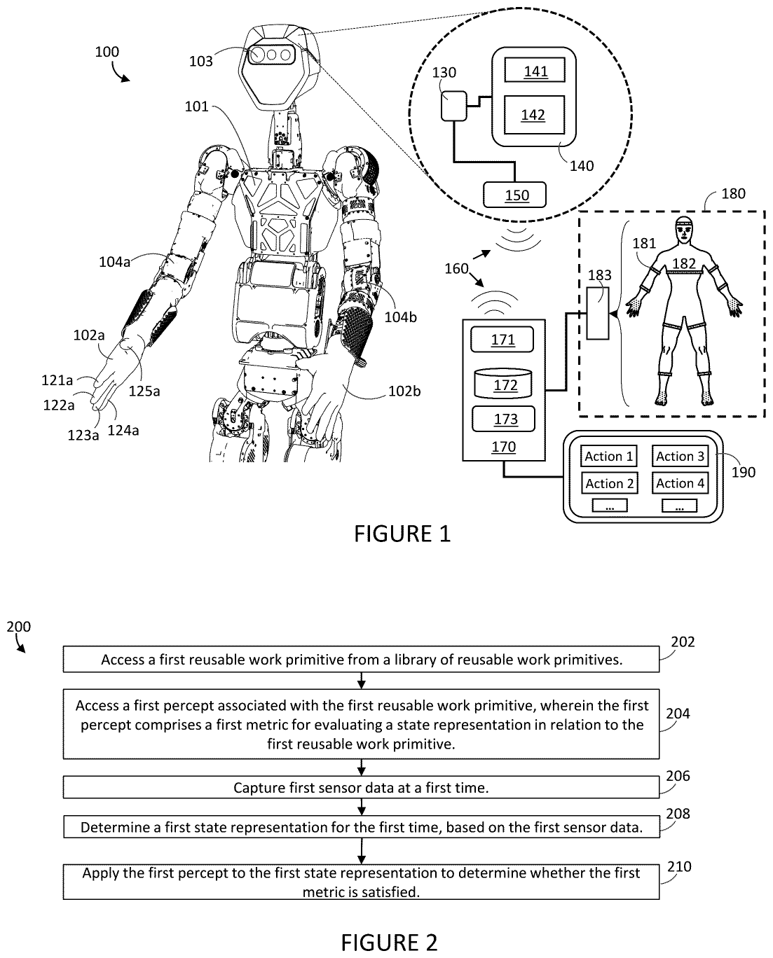

FIG. 1 is an illustrative diagram of an exemplary robot system 100 comprising various features and components described throughout the present robots, systems, robot control modules, computer program products, and devices. Robot system 100 comprises a robot body 101 with a first physically actuatable component 102a and a second physically actuatable component 102b mechanically coupled to body 101. In the illustrated implementation, first and second physically actuatable components 102a and 102b each correspond to a respective robotic hand, though a person of skill in the art will appreciate that in alternative implementations a physically actuatable component may take on other forms (such as an arm or leg, a non-hand-like end effector such as a cutter or suction tube, or any other form useful to the particular applications the robot is intended to perform). Robotic hand 102a emulates a human hand and includes multiple fingers 121a, 122a, 123a, and 124a and an opposable thumb 125a. Robotic hand 102b is similar to a mirror-image of robotic hand 102a while corresponding details are not labeled for robotic hand 102b to reduce clutter. Robotic hands 102a and 102b may be physically actuatable by a variety of different means, including electromechanical actuation, cable-driven actuation, magnetorheological fluid-based actuation, and/or hydraulic actuation. Some exemplary details of actuation technology that may be employed to physically actuate robotic hands 102a and 102b are described in U.S. patent application Ser. No. 17/491,577 and U.S. patent application Ser. No. 17/749,536, both of which are incorporated by reference herein in their entirety.

Robot body 101 further includes at least one sensor 103 that detects and/or collects data about the environment and/or objects in the environment of robot system 100, and/or data about the robot system 100 or robot body 101. In the example, the at least one sensor 103 includes at least one image sensor (e.g. a camera) that captures visual data representing an environment of robot body 101. Although three image sensors 103 are illustrated, more or fewer image sensors could be included. As another example, the at least one sensor 103 can include any appropriate number of audio sensors (e.g. microphones) that capture audio data representing an environment of robot body 101. As another example, haptic (tactile) sensors can be included, such as on actuatable components 102a and 102b. Such haptic sensors can capture haptic data (or tactile data) when objects in an environment are touched or grasped by actuatable components 102a and 102b. Haptic or tactile sensors could also be included on other areas or surfaces of robot body 101. In the illustrated example, sensors such as image sensors, audio sensors, haptic sensors, or tactile sensors can be considered as “environment sensors”, in that these sensors generally (but not exclusively) capture information regarding an environment in which robot body 101 is positioned. That is, image sensors capture image data, audio sensors capture audio data, and tactile sensors capture tactile data, each of which generally represents the environment or objects in the environment. However, in some scenarios it is also possible that each of these sensor types capture data representing the robot body (e.g. image data showing parts of the robot body 101, audio data representing sounds made by robot body 101, tactile data representing touch of parts of robot body 101). Thus, while the term “environment sensor” provides a convenient general grouping of sensors, this term is not strictly limiting.

Also in the example, robot body sensor 104a is included in an arm of robot body 101, and robot body sensor 104b is included in another arm of robot body 101. Robot body sensors such as sensors 104a and 104b can include a variety of possible sensors. In some examples, a robot body sensor includes an actuator sensor which captures actuator data indicating a state of a corresponding actuator. In some examples, a robot body sensor includes a position encoder which captures position data about at least one joint or appendage of the robot body. In some examples, a robot body sensor includes a proprioceptive sensor which captures proprioceptive data indicating a position, movement, or force applied for a corresponding actuatable member of the robot body. More specifically, proprioceptive sensors can capture proprioceptive data, which can include the position(s) of one or more actuatable member(s) and/or force-related aspects of touch, such as force-feedback, resilience, or weight of an element, as could be measured by a torque or force sensor (acting as a proprioceptive sensor) of an actuatable member which causes touching of the element. While two robot body sensors 104a and 104b are illustrated in FIG. 1, any appropriate number of robot body sensors can be included in a robot body in a given application. In the illustrated example, sensors such as actuator sensors, position encoders, proprioceptive sensors, torque sensors, force sensors, or any other similar sensors can be considered as “robot body sensors”, in that these sensors generally (but not exclusively) capture information regarding robot body 101 itself. However, in some scenarios it is also possible that each of these sensor types capture data representing the environment (e.g. tactic, haptic, or proprioceptive data indicating contact or attributes of an element of the environment). Thus while the term “robot body sensor” provides a convenient general grouping of sensors, this term is not strictly limiting.

For the purposes of illustration, FIG. 1 includes details of certain exemplary components that are carried by or within robot body 101 in accordance with the present robots, systems, computer program products, robot control modules, and devices. Such components include at least one processor 130 and at least one non-transitory processor-readable storage medium, or “memory”, 140 communicatively coupled to processor 130. Processor 130 and memory 140 can be collectively be referred to as a “robot controller”, which controls operation of the robot. Memory 140 can store at least one library of reusable work primitives 141 (which may or may not include a library of reusable grasp primitives for either or both of robotic hands 102a and/or 102b depending on the implementation) and processor-executable instructions 142 that, when executed by processor 130, cause robot body 101 (including applicable actuatable components such as either or both of robotics hands 102a and/or 102b) to selectively and autonomously perform at least one reusable work primitives in library of reusable work primitives 141. In some implementations, memory 140 stores an entire catalog of reusable work primitives usable by the robot. To reduce processing burden, the catalog of reusable work primitives can be organized into a plurality of libraries of work primitives, each library including fewer reusable work primitives than the catalog of reusable work primitives. The at least one processor 130 accesses each library as needed to accomplish a given work objective, execute a given workflow, or select work primitives for a workflow. Depending on the specific implementation, processor-executable instructions 142 may further include processor-executable instructions (e.g., a computer program product or robot control module) that when executed cause robot system 100 to perform any or all of methods 200, 400, 500, 600, 700, 800, 900, 1000, and/or 1100 described herein. Further, memory 140 can store at least one library of percepts associated with reusable work primitives stored at memory 140.

Processor 130 is also illustrated as being communicatively coupled to a wireless transceiver 150 via which robot body 101 sends and receives wireless communication signals 160 with an exemplary teleoperation system 170. To this end, teleoperation system 170 also includes a wireless transceiver 171.

Teleoperation system 170 as illustrated includes at least one non-transitory processor-readable storage medium 172 and at least one processor 173, which collectively can be referred to as a robot controller. In some implementations, the robot controller of robot body 101 (processor 130 and memory 140) can be omitted or reduced in purpose, with the robot controller of teleoperation system 170 serving to control robot body 101 remotely. In other implementations, the robot controller of robot body 101 (processor 130 and memory 140) can cooperate with the robot controller of teleoperation system 170, to together control robot body 101. In yet other implementations, teleoperation system 170 can be omitted, such that the robot controller of robot body 101 (processor 130 and memory 140) control robot body 101 generally independently. Depending on the specific implementation, the at least one non-transitory processor-readable storage medium 172 may store processor-executable instructions (e.g., a computer program product or robot control module) that when executed cause robot system 100 to perform any or all of methods 200, 400, 500, 600, 700, 800, 900, 1000, and/or 1100 described herein.

The at least one non-transitory processor-readable storage medium (memory) 172 can optionally store reusable work primitives and/or associated percepts for access by the robot controller(s). This is particularly useful when memory 140 does not store an entire catalog of reusable work primitives usable by the robot system. In such an implementation, the entire catalog of reusable work primitives usable by the robot system can be stored on the memory 172, for access by the robot as needed. As discussed above, the catalog of reusable work primitives is organized into libraries of work primitives, where the robot system can access libraries of reusable work primitives as needed. As needed, at least one library of reusable work primitives can be transferred from teleoperation system 170 to the robot body 101 via wireless transceivers 171 and 150, and stored on memory 140.

In the illustrated example, teleoperation system 170 includes both a low-level teleoperation interface 180 and a high-level teleoperation interface 190. Low-level teleoperation interface 180 includes a sensor system 181 that detects real physical actions performed by a human pilot 182 and a processing system 183 that converts such real physical actions into low-level teleoperation instructions that, when executed by processor 130, cause robot body 101 (and any applicable actuatable components such as hands 102a and/or 102b) to emulate the physical actions performed by pilot 182. In some implementations, sensor system 181 may include many sensory components typically employed in the field of virtual reality games, such as haptic gloves, accelerometer-based sensors worn on the body of pilot 182, and a VR headset that enables pilot 182 to see optical data collected by sensor 103 of robot body 101. High-level teleoperation interface 190 includes a simple GUI displayed, in this exemplary implementation, on a tablet computer. The GUI of high-level teleoperation interface 190 provides a set of buttons each corresponding to a respective action performable by robot body 101 (and applicable actuatable components such as hands 102a and/or 102b). Action(s) selected by a user/pilot of high-level teleoperation interface 190 through the GUI are converted into high-level teleoperation instructions that, when executed by processor 130, cause robot body 101 (and any applicable actuatable components such as hands 102a and/or 102b) to perform the selected action(s).

Teleoperation system 170 can be implemented in a distributed manner. For example, memory 172 can be at a server location remote from low-level teleoperation interface 180 and/or remote from high-level teleoperation interface 190. As another example, low-level teleoperation interface 180 can be remote from high-level teleoperation interface 190.

Robot system 100 in FIG. 1 is illustrated such that the robot generally emulates or mimics human anatomy. However, this is not necessarily the case, and any appropriate form of robot could be used. In some implementations, a robot may only partially emulate human anatomy (e.g. the robot may only include a limited subset of human-like features), or a robot may not emulate human anatomy at all.

FIG. 2 is a flow diagram showing an exemplary method 200 of operation of a robot system (such as robot system 101 discussed with reference to FIG. 1). In general, throughout this specification and the appended claims, a method of operation of a robot system is a method in which at least some, if not all, of the various acts are performed by the robot system. For example, certain acts of a method of operation of a robot system may be performed by at least one processor or processing unit (hereafter “processor”) of the robot system communicatively coupled to a non-transitory processor-readable storage medium of the robot system (collectively a robot controller of the robot system) and, in some implementations, certain acts of a method of operation of a robot system may be performed by peripheral components of the robot system that are communicatively coupled to the at least one processor, such as one or more physically actuatable components (e.g., arms, legs, end effectors, grippers, hands), one or more sensors (e.g., optical sensors, audio sensors, tactile sensors, haptic sensors), mobility systems (e.g., wheels, legs), communications and networking hardware (e.g., receivers, transmitters, transceivers), and so on. The non-transitory processor-readable storage medium of the robot system may store data (including, e.g., at least one library of reusable work primitives and at least one library of associated percepts) and/or processor-executable instructions that, when executed by the at least one processor, cause the robot system to perform the method and/or cause the at least one processor to perform those acts of the method that are performed by the at least one processor. The robot system may communicate, via communications and networking hardware communicatively coupled to the robot system's at least one processor, with remote systems and/or remote non-transitory processor-readable storage media. Thus, unless the specific context requires otherwise, references to a robot system's non-transitory processor-readable storage medium, as well as data and/or processor-executable instructions stored in a non-transitory processor-readable storage medium, are not intended to be limiting as to the physical location of the non-transitory processor-readable storage medium in relation to the at least one processor of the robot system and the rest of the robot hardware. In other words, a robot system's non-transitory processor-readable storage medium may include non-transitory processor-readable storage media located on-board a robot body of the robot system and/or non-transitory processor-readable storage media located remotely from the robot body, unless the specific context requires otherwise. Further, a method of operation of a robot system such as method 200 (or any of the other methods discussed herein) can be implemented as a computer program product. Such a computer program product comprises processor-executable instructions or data that, when the computer program product is stored on a non-transitory processor-readable storage medium of the robot system, and the computer program product is executed by at least one processor of the robot system, the computer program product (or the processor-executable instructions or data thereof) cause the robot system to perform acts of the method.

Returning to FIG. 2, method 200 as illustrated includes acts 202, 204, 206, 208, and 210, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 202, a first reusable work primitive from a library of reusable work primitives is accessed by a robot controller (e.g. by processor 130 or processor 173). In some implementations, the library of reusable work primitives, which includes the first reusable work primitive which the robot accesses, is stored locally at the robot body (e.g. on memory 140). To this end, libraries relevant to a service category which a robot is expected or intended to operate in, or libraries which the robot might foreseeably need during a deployment, can be pre-loaded onto the memory 140 prior to deployment. In such a case, accessing the first reusable work primitive from the library of reusable work primitives as at 202 comprises accessing the first reusable work primitives stored on the at least one non-transitory processor-readable storage medium of the robot body (e.g. memory 140).

In other implementations, the library of reusable work primitives, which includes the first reusable work primitive which the robot accesses, is not stored locally at the robot body. In such implementations, accessing the first reusable work primitive from the library of reusable work primitives can comprise accessing via the communication interface of the robot body (e.g. wireless transceiver 150), the first reusable work primitive stored on at least one remote non-transitory processor-readable storage medium of a device remote from the robot (e.g. memory 172 of teleoperation device 170). That is, libraries of reusable work primitives can be stored remotely from the robot body, such as on a teleoperation device or on a server accessible to the robot body, and the robot can access libraries of reusable work primitives as needed. This enables flexibility in the event that the objectives or tasks faced by the robot system don't align with the reusable work primitives the robot body was pre-loaded with.

In yet other implementations, the robot controller is at least partially remote from the robot body (e.g. the at least one processor and at least one non-transitory processor-readable storage medium are remote from the robot body), and the library of reusable work primitives, which includes the first reusable work primitive which the robot accesses, is not stored locally at the robot body. In such implementations, accessing the first reusable work primitive from the library of reusable work primitives can comprise accessing the first reusable work primitive stored on at least one remote non-transitory processor-readable storage medium (e.g. memory 172) of a device remote from the robot body (e.g. teleoperation device 170), by the robot controller remote from the robot.

At 204, a first percept associated with the first reusable work primitive is accessed by the robot controller (e.g. by processor 130 or processor 173). As discussed earlier, the first percept comprises a first metric for evaluating a state representation in relation to the first reusable work primitive (e.g. a metric representing a success state, at least one fail state, or any other appropriate means for evaluating a state representation). Accessing the first percept can be performed in a similar manner (or even together with) accessing the first reusable work primitive in act 202, either locally at the robot body (e.g. stored on memory 140) or remote from the robot body (e.g. stored on memory 172).

At 206, first sensor data is captured by at least one sensor (such as sensor 103) at a first time. In some implementations, the at least one sensor comprises at least one environment sensor (as discussed earlier) which captures first environment data representing an environment of the robot body at the first time. In other implementations, the at least one sensor comprises at least one robot body sensor (as discussed earlier) which captures first robot body data representing a configuration of the robot body at the first time. In yet other implementations, the at least one sensor comprises at least one environment sensor (as discussed earlier) which captures first environment data representing an environment of the robot body at the first time, and the at least one sensor further comprises at least one robot body sensor (as discussed earlier) which captures first robot body data representing a configuration of the robot body at the first time.

At 208, a first state representation is determined for the first time by the at least one processor.

In implementations where the first sensor data includes first environment data, in act 208 the at least one processor (of the robot controller) determines the first state representation as a state of the environment of the robot body based on the first environment data. For example, the at least one processor can generate or populate a map or model of the environment of the robot body, including objects or features in the environments, their positioning or spatial attributes relative to the robot body, characteristics of objects or features in the environment, or any other features of the environment as appropriate for a given application. Determining the state representation in such implementations can include executing or utilizing object or feature detection models appropriate for respective environment data captured (e.g. image-based object and feature detection models for captured image data).

In implementations where the first sensor data includes first robot body data, in act 208 the at least one processor determines the first state representation as a configuration of the robot body based on the first robot body data. For example, the at least one processor can determine position and orientation of elements of the robot body, as well as other attributes of the robot body such as force applied by at least one actuatable member, etcetera.

In implementations where the first sensor data includes first environment data and first robot body data, in act 208 the at least one processor determines the first state representation as a representation of the environment of the robot body and as configuration of the robot body based on the first robot body data (e.g. as a configuration of the robot body within a representation of the environment).

At 210, the at least one processor applies the first percept to the first state representation, to determine whether the first metric is satisfied. In an exemplary implementation where the first metric corresponds to a success state (e.g. the first percept represents a state of the environment and/or robot body where expected results of the first reusable work primitive are successfully achieved), the at least one processor can compare the first state representation to the success state, and determine that the first metric is satisfied if there are no major discrepancies between the first state representation and the success state representation. In another exemplary implementation where the first percept corresponds to at least one failure condition (e.g. the first percept represents one more or states where expected results of the first reusable work primitive are not achieved), the at least one processor can compare the first state representation to the at least one failure conditions, and determine that the first metric is satisfied if the first state representation does not fulfill any of the at least one failure conditions. As a non-limiting example, a failure condition could include a torque or force data collected by a torque or force sensor exceeding a certain threshold (indicating for example that an element of the robot body has collided unexpectedly with something). As another non-limiting example, a failure condition could include an element of the robot body not reaching an expected position (e.g. because the element was unable to move as expected).

Regardless of whether a percept represents a success state or failure conditions, any percept (e.g. the first percept in method 200) can be a Boolean function which returns either true or false.

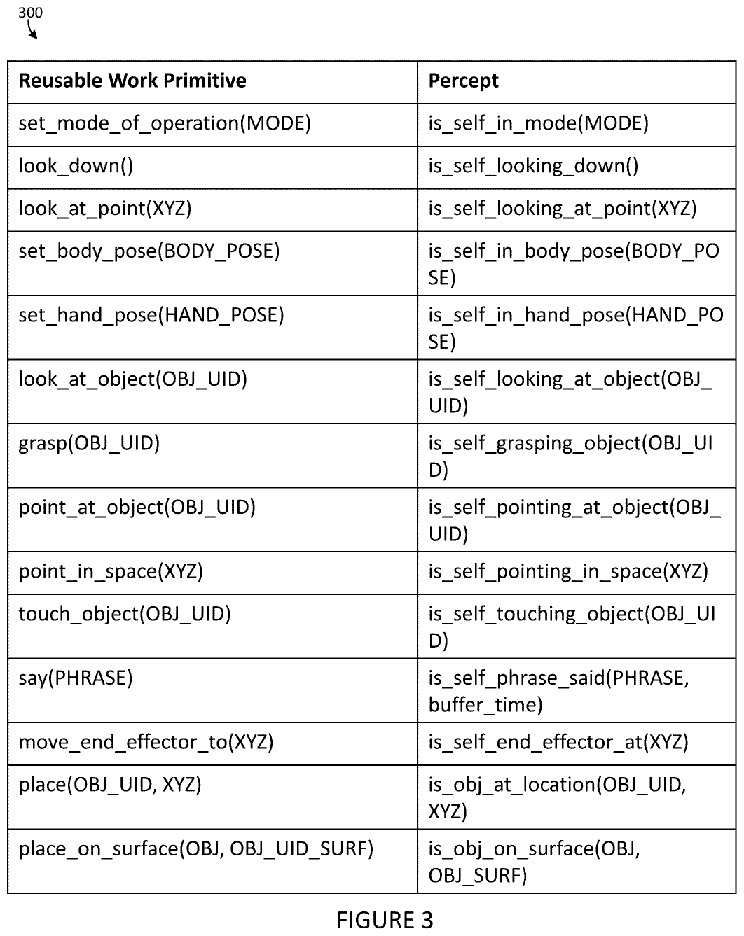

FIG. 3 illustrates a table 300 which includes several exemplary and non-limiting reusable work primitives, and associated percepts. Throughout this discussion, the abbreviation “OBJ” or “obj” refers to “object”; the term “XYZ” refers to a position in three-dimensional space, specified using any appropriate coordinate system and relevant origin point; the acronym “UID” refers to a “unique identifier”, which uniquely specifies a given object, feature, or other element in an environment; and the abbreviation “SURF” refers to a surface.

Table 300 includes a reusable work primitive “set_mode_of_operation”, which takes an input “MODE”. This reusable work primitive sets a mode of operation of a robot system, in accordance with the input MODE (which could be an integer indication of a particular mode in a library of set of available modes). The associated percept “is_self_in_mode” takes an input “MODE”, and is a Boolean function which checks whether the mode of operation corresponds to the input “MODE”. The Boolean function returns “true” if the robot system is in the input “MODE”, and returns false otherwise. Such a Boolean function could entail, for example, accessing operational data of the robot system indicating a mode of operation of the robot body.

Table 300 shows another reusable work primitive “look_down”, which in this example takes no input (though in alternative implementations, an input could specifying where or what direction to look more specifically). This reusable work primitive causes the robot body to “look” down (e.g. by tilting a head of the robot body towards the ground). The associated percept “is_self_looking_down” is a Boolean function which checks whether the robot body is looking down. The Boolean function returns “true” if the robot system is looking down, and returns false otherwise. Such a Boolean function could entail, for example, accessing robot body data indicating a position and/or orientation of the head of the robot body (e.g. from actuable member sensors in a neck of the robot body, or from gyroscopic or inertial sensors in a head of the robot body), and checking whether the position and/or orientation of the head is within a threshold considered as “down”.

Table 300 shows several other reusable work primitives and corresponding percepts, which can be understood as being similar to the above, and from FIG. 3 itself, such they are not each expanded on in detail.

Returning to method 200 in FIG. 2, in some implementations an indication of metric satisfaction can be output if the first metric is determined as satisfied at 210. Similarly, an indication of metric non-satisfaction can be output if the first metric is determined as not satisfied at 210. Outputting these indications could for example comprise storing results of applying the first percept in at least one non-transitory processor-readable storage medium, for later use. Additionally or alternatively, outputting these indications could for example comprise sending the indications to another device (such as from robot body 101 to teleoperation device 170 in FIG. 1).

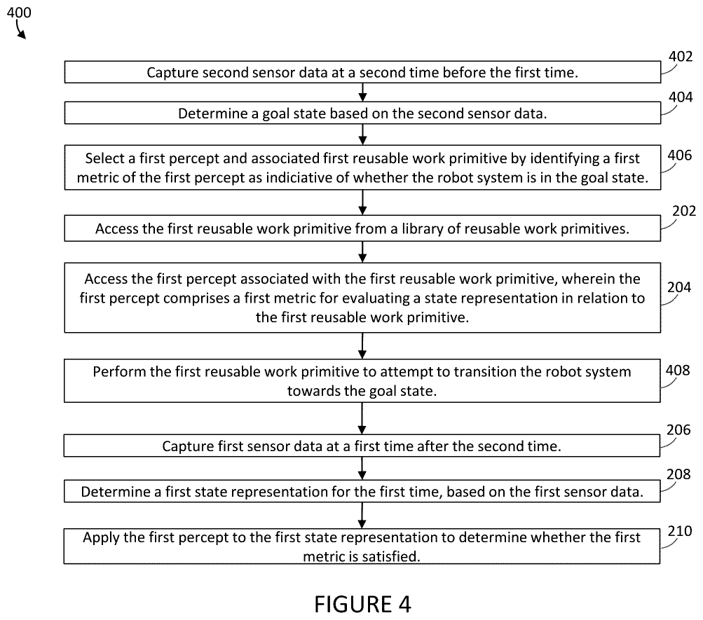

Percepts are useful for checking the results of performing a reusable work primitive, after performing said reusable work primitive. This can be referred to as “post-condition evaluation”. FIG. 4 discussed below illustrates an example of post-condition evaluation.

FIG. 4 is a flow diagram showing an exemplary method 400 of operation of a robot system. Method 400 in FIG. 4 is an extension of method 200 in FIG. 2. Description of method 200 in FIG. 2 is fully applicable to method 400 in FIG. 4 unless context dictates otherwise. Method 400 as illustrated includes acts 402, 404, 406, 202, 204, 408, 206, 208, and 210, though those of skill in the art will appreciate that in alternative implementations certain acts may be omitted and/or additional acts may be added. Those of skill in the art will also appreciate that the illustrated order of the acts is shown for exemplary purposes only and may change in alternative implementations. Description of acts 202, 204, 206, 208 and 210 with respect to method 200 is fully applicable to similarly numbered acts in method 400.

At 402, second sensor data is captured by at least one sensor at a second time (before the first time discussed with reference to act 206). Capturing of sensor data as discussed earlier with reference to the first sensor data is fully applicable to the capturing of second sensor data in act 402, and is not repeated for brevity.

At 404, the at least one processor (of a robot controller) determines a goal state based on the second sensor data. Such a goal state can be, for example, an appropriate state for the robot system to achieve a work objective, as described earlier, and described in more detail later with reference to FIGS. 8, 9, 10, and 11.

At 406, the first percept and associated first reusable work primitive are selected by the at least one processor, by identifying the first metric for the first percept as indicative of whether the robot system is in the goal state. That is, the first percept is selected as being appropriate for evaluating whether the robot system is in the goal state, and the associated first reusable work primitive is selected as being appropriate to transition the robot system to the goal state.

At 202 and 204, the first reusable work primitive and the associated first percept are accessed, as discussed earlier with reference to method 200.

At 408, the first reusable work primitive is performed to attempt to transition the robot system towards the goal state. That is, the at least one processor of the robot controller executes instructions which cause the robot system to act in accordance with the first reusable work primitive.

At 206 and 208, first sensor data is captured to determine a first state representation for the first time, as discussed above with reference to method 200. At 210, the first percept is applied to the first state representation to determine whether the first metric is satisfied, as discussed earlier with reference to method 200.

Method 400 expands on method 200, to illustrate an exemplary scenario where second sensor data is used to determine a goal state, a first reusable work primitive is selected to attain the goal state, and the associated first percept is applied to evaluate whether the goal state is achieved after performing the reusable work primitive. In this way, method 400 illustrates a scenario where results of executing a reusable work primitive are evaluated, to determine if desired results are achieved. By determining a state representation based on sensor data, and applying a percept to the state representation, an actual resulting state of the robot system is assessed. This provides advantages over other evaluation methodologies, such as “action complete” messaging, where a message or flag is output indicating that a reusable work primitive has been executed. As a non-limiting example, the first reusable work primitive may be intended to cause the robot system to position a first object on a second object, but in doing so the robot system may knock over the second object. An action complete message may not identify this correctly, and may simply indicate that the robot body finished moving the first object. On the other hand, determining a state representation and applying a percept, as in methods 200 and 400, can identify issues in the state (e.g. that the second object is knocked over), and thereby can produce more accurate results.

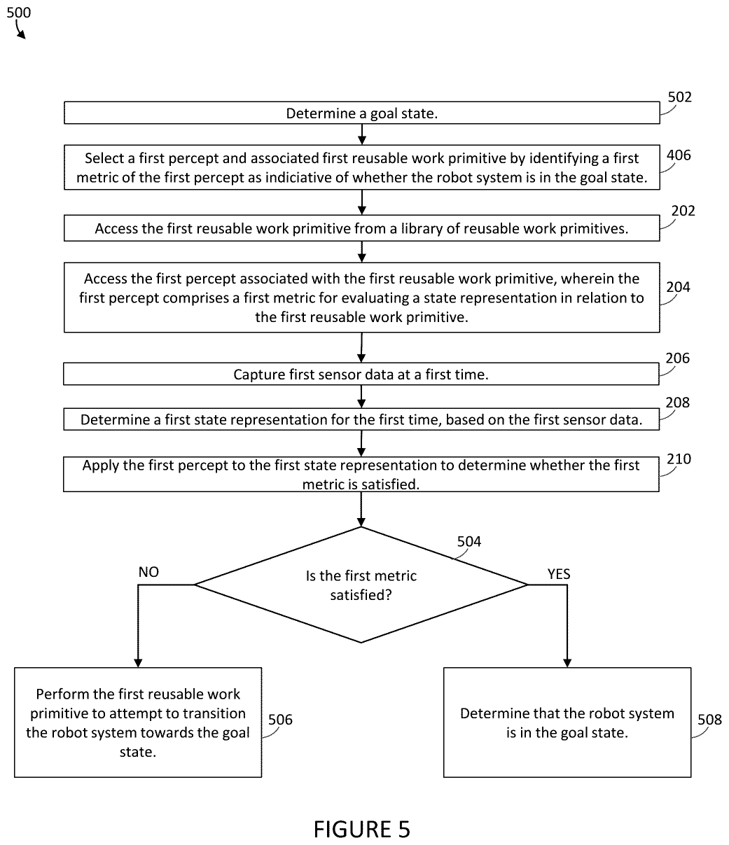

Percepts are also useful for checking a state representation prior to performing a reusable work primitive. This can be referred to as “pre-condition evaluation”. FIG. 5 discussed below illustrates an example of pre-condition evaluation.

FIG. 5 is a flow diagram showing an exemplary method 500 of operation of a robot system. Method 500 in FIG. 5 is an extension of method 200 in FIG. 2. Description of method 200 in FIG. 2 is fully applicable to method 500 in FIG. 5 unless context dictates otherwise. Further, some description of method 400 in FIG. 4 also applies to method 500 in FIG. 5. Method 500 as illustrated includes acts 502, 406, 202, 204, 206, 208, 210, 506 and 508, though those of skill in the art will appreciate that in alternative implementations certain acts may be omitted and/or additional acts may be added. Those of skill in the art will also appreciate that the illustrated order of the acts is shown for exemplary purposes only and may change in alternative implementations. Description of acts 202, 204, 206, 208 and 210 with respect to method 200 is fully applicable to similarly numbered acts in method 500. Further, description of act 406 in methoatentd 400 is fully applicable to similarly numbered act 406 in method 500.

At 502, the at least one processor determines a goal state. Such a goal state can be, for example, an appropriate state for the robot system to achieve a work objective, as described earlier, and described in more detail later.

At 406, the first percept and associated first reusable work primitive are selected, by identifying the first metric for the first percept as indicative of whether the robot system is in the goal state, similarly to as discussed with reference to method 400.

At 202 and 204, the first reusable work primitive and the associated first percept are accessed, as discussed earlier with reference to method 200.

At 206 and 208, first sensor data is captured to determine a first state representation for the first time, as discussed above with reference to method 200. At 210, the first percept is applied to the first state representation to determine whether the first metric is satisfied, as discussed earlier with reference to method 200.

Based on the results of act 210, method 500 proceeds to act 506 or act 508, as shown at 504. If the first metric is determined at 210 as not being satisfied, method 500 proceeds to 506, where the robot system performs the first reusable work primitive to attempt to transition the robot system towards the goal state. That is, the at least one processor of the robot system executes instructions which cause the robot system to act in accordance with the first reusable work primitive. If the first metric is determined at 210 as being satisfied, method 500 proceeds to act 508, where the at least one processor determines that the robot system is already in the goal state (without needing to execute the first reusable work primitive).

Method 500 expands on method 200, to illustrate an exemplary scenario where a goal state is determined, a first reusable work primitive is selected corresponding to the goal state, and the associated first percept is applied to evaluate whether the goal state is already achieved prior to executing the first reusable work primitive. In this way, redundancy and errors can be reduced by preventing the robot system from performing needless or excessive reusable work primitives. As a non-limiting example, a first robot working an assembly line may determine a goal state where an identified faulty product is removed from the assembly line. However, a second robot may remove the faulty product prior to the first robot being able to. In this example, when the first robot applies the first percept in act 210 of method 500, the first metric is satisfied, and the robot does not need to perform a reusable work primitive to remove the (already removed) faulty product.

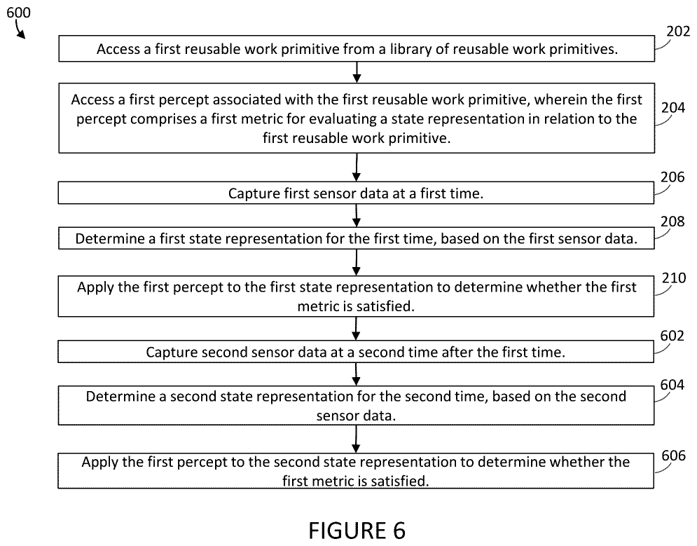

Percepts are also useful for evaluating maintenance of a state (i.e. that a state or aspects of a state are unchanged over time). FIG. 6 discussed below illustrates an example of evaluating maintenance of state.

FIG. 6 is a flow diagram showing an exemplary method 600 of operation of a robot system. Method 600 in FIG. 6 is an extension of method 200 in FIG. 2. Description of method 200 in FIG. 2 is fully applicable to method 600 in FIG. 6 unless context dictates otherwise. Further, some description of method 400 in FIG. 4 and method 500 in FIG. 5 also applies to method 600 in FIG. 6. Method 600 as illustrated includes acts 202, 204, 206, 208, 210, 602, 604, and 606, though those of skill in the art will appreciate that in alternative implementations certain acts may be omitted and/or additional acts may be added. Those of skill in the art will also appreciate that the illustrated order of the acts is shown for exemplary purposes only and may change in alternative implementations. Description of acts 202, 204, 206, 208 and 210 with respect to method 200 is fully applicable to similarly numbered acts in method 600.

At 202 and 204, the first reusable work primitive and the associated first percept are accessed, as discussed earlier with reference to method 200. At 206 and 208, first sensor data is captured to determine a first state representation for the first time, as discussed above with reference to method 200. At 210, the first percept is applied to the first state representation to determine whether the first metric is satisfied, as discussed earlier with reference to method 200.

At 602, second sensor data is captured by the at least one sensor at a second time after the first time. Similar to as discussed above with reference to act 402 of method 400, capturing of the second sensor data is similar to capturing the first sensor data as discussed with reference to act 206 in method 200.

At 604, a second state representation for the second time is determined by the at least one processor based on the second sensor data. Determining the second state representation is similar to determining the first state representation as discussed with reference to act 208 in method 200, but based on different sensor data.

At 606, the at least one processor applies the first percept to the second state representation to determine whether the first metric is satisfied. Applying of the first percept to the second state representation is similar to applying the first percept to the first state representation in act 210 of method 200, but the state representation to which the first percept is applied is different.

Method 600 expands on method 200, to illustrate an exemplary scenario where a first state representation is evaluated, and subsequently a second state representation is evaluated by the same percept. In this way, maintenance of state is evaluated based on the first percept. As one non-limiting example, a robot system may place a first object on top of a second object (using the first reusable work primitive), evaluate that the first object is indeed on top of the second object in act 210, and subsequently confirm that the first object is still on top of the second object at a later time as in acts 602, 604, and 606.

As is evident from the above discussion, use of the labels “first” and “second” with regards to time does not indicate a particular order for the times (e.g. the second time can be before the first time, or the second time can be after the first time, as appropriate in a given implementation).

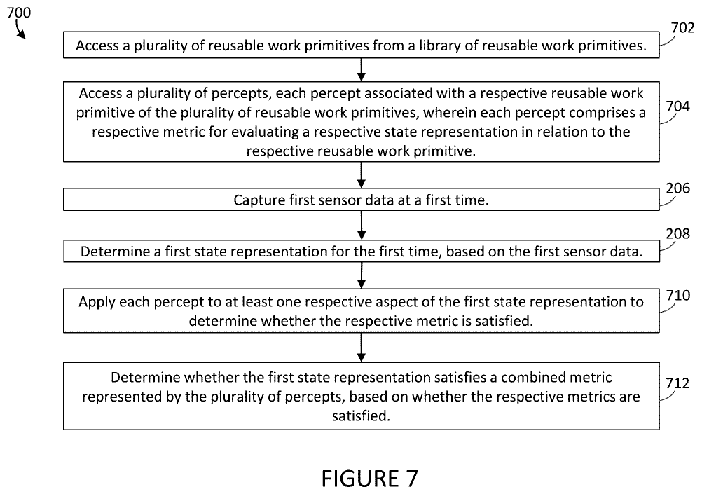

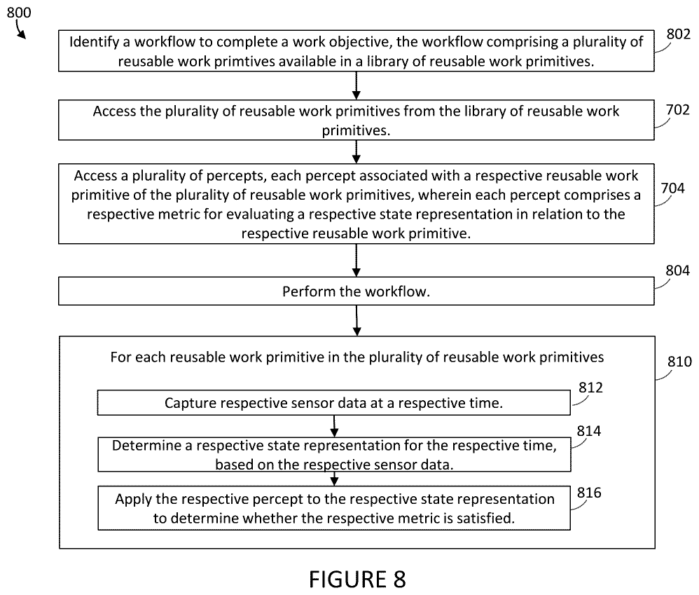

In some implementations, a state of the robot system includes a plurality of aspects. Each aspect can be evaluated by applying a respective percept, and the state as a whole is evaluated by evaluating a combination of the percepts to determine whether a combined metric is satisfied for the robot system. This is discussed below with reference to FIG. 7.

FIG. 7 is a flow diagram showing an exemplary method 700 of operation of a robot system. Method 700 in FIG. 7 is similar to and expands on method 200 in FIG. 2. Description of method 200 in FIG. 2 is fully applicable to method 700 in FIG. 7 unless context dictates otherwise. Method 700 as illustrated includes acts 702, 704, 206, 208, 710, and 712, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 702, a plurality of reusable work primitives are accessed from a library of reusable work primitives. This is similar to accessing the first reusable work primitive in act 202 of method 200, and description of act 202 is fully applicable to act 702 in method 700. Further, the first reusable work primitive can be included in the accessed plurality of reusable work primitives.

At 704, a plurality of percepts are accessed by the at least one processor. Each percept in the plurality of percepts is associated with a respective reusable work primitive of the plurality of reusable work primitives accessed at 702. Each percept comprises a respective metric for evaluating a respective state representation in relation to the respective reusable work primitive. Accessing the plurality of percepts is similar to accessing the first percepts in act 204 of method 200, and description of act 204 is fully applicable to act 704 in method 700. Further, the first percept can be included in the accessed plurality of percepts.

At 206 and 208, first sensor data is captured to determine a first state representation for the first time, as discussed above with reference to method 200.

At 710, each percept is applied by the at least one processor to at least one respective aspect of the first state representation to determine whether the respective metric is satisfied. Applying of percepts is similar to applying the first percept as discussed earlier with reference to act 210 in method 200, and the earlier discussion is fully applicable to act 710 of method 700. In some implementations, act 710 causes the at least one processor to output an indication of metric satisfaction for each respective aspect of the first state representation which satisfies the respective metric, and to output an indication of metric non-satisfaction for each respective aspect of the first state representation which does not satisfy the respective metric. As discussed earlier, such indications can include storing a result of applying the respective metric in memory for later use, transmitting the indication to another device, or any other appropriate form of indication.

At 712, the at least one processor determines whether a combined metric represented by the plurality of percepts, based on whether the respective metrics are satisfied.

For ease of understanding, an exemplary scenario is discussed below where method 700 is utilized, with reference to the exemplary reusable work primitives and associated percepts illustrated in table 300 in FIG. 3. In the exemplary scenario, a robot system aims to look down, reach toward a ball, and grasp the ball.

In accordance with act 702, accessing a plurality of reusable work primitives from a library of reusable work primitives entails accessing a first reusable work primitive of “look_down( )”, a second reusable work primitive of “set_body_pose(reach)”, and a third reusable work primitive of “grasp(ball)”. In this example, the “reach” pose corresponds to a pose where an arm of the robot body is extended outwards, and “ball” is representative of a UID for the ball.

In accordance with act 704, accessing a plurality of percepts entails access a first percept of “is_self_looking_down( )” which is associated with the first reusable work primitive, a second percept of “is_self_in_body_pose(reach)” which is associated with the second reusable work primitive, and a third percept of “is_self_grasping_object(ball)” which is associated with the third reusable work primitive. The first percept comprises a first metric for evaluating a state representation in relation to the “look_down( )” reusable work primitive (i.e. the “is_self_looking_down( )” percept includes a metric for evaluating whether the robot body is looking down). The second percept comprises a second metric for evaluating a state representation in relation to the “set_body_pose(reach)” reusable work primitive (i.e. the “is_self_in_body_pose(reach)” percept includes a metric for evaluating whether the robot body is in the “reach” pose). The third percept comprises a third metric for evaluating a state representation in relation to the “grasp(ball)” reusable work primitive (i.e. the “is_self_grasping_object(ball)” percept includes a metric for evaluating whether the robot body is grasping the ball).

At 206 and 208, first sensor data is captured to determine a first state representation for the first time, as discussed above with reference to method 200.

In accordance with act 710, the first percept is applied to determine whether the robot body is looking down in the first state representation, the second percept is applied to determine whether the robot is in the “reach” pose in the first state representation, and the third percept is applied to determine whether the robot is grasping the ball in the first state representation. In this sense, each “aspect” of the first state representation is evaluated by a respective percept. In the exemplary scenario, the looking direction of the robot is a first aspect of the first state representation evaluated by the first percept, the arm pose of the robot is a second aspect of the first state representation evaluated by the second percept, and the grasp state of the robot is a third aspect of the first state representation evaluated by the third percept.

In accordance with act 712, a combined metric is evaluated which incorporates the results of each of the plurality of metric in the plurality of percepts. In the exemplary scenario, an exemplary combined metric M is expressed in Equation (1) below:

$$M = is\_self \_looking \_down ( ) \qquad ( 1 )$$

$$AND is\_self \_in \_body \_pose ( reach )$$

$$AND is\_self \_grasping \_object ( ball )$$

In the example, each of the respective percepts (or metrics thereof) are Boolean functions which return either true or false (or equivalent representations such as 0=false and 1=true, or any other appropriate representation). Further, Equation (1) is itself a Boolean function which takes as inputs the results of each Boolean metric (e.g. by accessing respective indications of metric satisfaction or metric non-satisfaction for each metric).

In the exemplary scenario, using Equation (1), in act 712 the first state representation is determined as satisfying the combined metric if each respective aspect of the first state representation satisfies the respective metric of the respective percept applied to the respective aspect of the first state representation. That is, in this example, if each metric is satisfied, the combined metric is satisfied. Conversely, in the exemplary scenario using Equation (1), in act 712 the first state representation is determined as NOT satisfying the combined metric if at least one aspect of the first state representation does NOT satisfy the respective metric of the respective percept applied to the respective aspect of the first state representation. That is, in this example, if at least one metric is NOT satisfied, the combined metric is also NOT satisfied.

Equation (1) is merely exemplary, and other forms of combined metric are possible. As another example, a combined metric may not require that each metric be satisfied. With reference to the above exemplary scenario, the percept “is_self_looking_down( )” can be replaced by the percept “is_self_looking_up( )”. Given the right configuration and/or nature of sensors (e.g. image sensors with a wide field of view), the robot can be determined as sufficiently “looking down” by determining that the robot is NOT “looking up”. In such an example, a combined metric M could instead be as shown in Equation (2) below:

$$M = NOT is\_self \_looking \_up ( ) \qquad ( 2 )$$

$$AND is\_self \_in \_body \_pose ( reach )$$

$$AND is\_self \_grasping \_object ( ball )$$

In the example of Equation (2), in act 712 the first state representation is determined as satisfying the combined metric if the first metric is NOT satisfied, and the second and third metric are satisfied. Conversely, in the example of Equation (2), in act 712 the first state representation is determined as NOT satisfying the combined metric if the first metric is satisfied, the second metric is NOT satisfied, or the third metric is NOT satisfied.

The specific number of reusable work primitives and percepts, as well as the specific nature of the reusable work primitives and percepts, can be chosen as appropriate for a given application. Further, an equation for a combined metric can be chosen as appropriate, based on any combination of individual metrics being satisfied or not satisfied.

FIG. 8 is a flow diagram showing an exemplary method 800 of operation of a robot system. Method 800 in FIG. 8 is similar to and expands on method 200 in FIG. 2 and method 700 in FIG. 7. Description of method 200 in FIG. 2 and method 700 in FIG. 7 is fully applicable to method 800 in FIG. 8 unless context dictates otherwise. Method 800 as illustrated includes acts 802, 702, 704, 804, and 810 (including sub-acts 812, 814, and 816), though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 802, a workflow is identified by a robot controller (e.g. processor 130 or processor 173) to complete a work objective. The workflow comprises a plurality of reusable work primitives available in a library of reusable work primitives.

In some implementations, identifying the workflow comprises receiving an indication of the workflow, e.g. as input by a user via teleoperation interface 180 or teleoperation interface 190. In other implementations, the identification, by the robot controller, of the first workflow at 802 may include the robot controller itself autonomously identifying a first set, combination, and/or permutation of reusable work primitives that make up the first workflow. In such implementations, the non-transitory processor-readable storage medium of the robot controller (e.g. memory 140 or memory 172) may store data, models, policies, paradigms, algorithms, frameworks, architectures, and/or processor-executable instructions (collectively, “artificial intelligence”) that, when executed by the at least one processor of the robot controller, cause the robot controller to autonomously identify the first workflow. The artificial intelligence may autonomously identify the first workflow based on a range of different parameters and/or criteria, including without limitation: sensor data, environmental factors, internal parameters, observations, and/or communications with other systems, robots, devices, or people. As an example, the robot system can include at least one sensor (such as the at least one sensor 103 in FIG. 1), which captures sensor data representing an environment of a robot body of the robot system (such as visual data representing the environment of a robot body, or location data representing a location of the robot body, as non-limiting examples) and/or sensor data representing a robot body of the robot system. Based on the sensor data, the at least one processor of the robot controller can identify the first workflow. For example, if the sensor data is representative of the robot being in front of a mirror, the robot controller may identify the first workflow by organizing a first set of work primitives to clean the mirror (such as described earlier). The identification of the first workflow by the robot controller does not have to be limited to being based on the sensor data, and can be based on additional data or information. For example, in some cases different cleaning products may be used at different times to clean the same objects or areas (i.e., different products may be used in a rotation). As a non-limiting example, sinks in a bathroom may be cleaned several times a day, with most of the cleanings being performed with a soap, and with one or two of the cleanings being performed with bleach. When identifying a workflow to accomplish the objective of cleaning a sink, a robot or teleoperation system which is organizing the first workflow can access time and/or date data, and the workflow can be defined to cause the robot to identify the correct cleaning solution, and grab said correct cleaning solution.

Context data received by the communication interface can be used by the robot controller to identify the first workflow in many situations, even independently of sensor data collected by at least one sensor of the robot system. As a non-limiting example, a hauling robot (a robot which moves objects between locations) may be carrying an object, but may not be able to identify what the object is (e.g. it may be in a non-descript box). In such a case, the robot controller may be able to access context data (e.g. a database stored on a server or teleoperation device) which indicates what object the robot is carrying. For example, the robot controller could access the database to determine what object was positioned at a location where the object was picked up from. As another example, the robot may be able to scan an optical code (e.g. barcode or QR code) on the box, and look up what object corresponds to the scanned code in the database. Based on what the object is, the first workflow can be identified to involve maneuvering the robot body to place the object in the correct location for said object.

At 702, the plurality of reusable work primitives are accessed from the library of reusable work primitives, similar to as discussed above for method 700.

At 704, a plurality of percepts are accessed by the at least one processor. Each percept in the plurality of percepts is associated with a respective reusable work primitive of the plurality of reusable work primitives accessed at 702. Each percept comprises a respective metric for evaluating a respective state representation in relation to the respective reusable work primitive. Accessing the plurality of percepts is similar to accessing the plurality of percepts in act 704 discussed with reference to method 700, and description of act 704 in method 700 is fully applicable to act 704 in method 800.

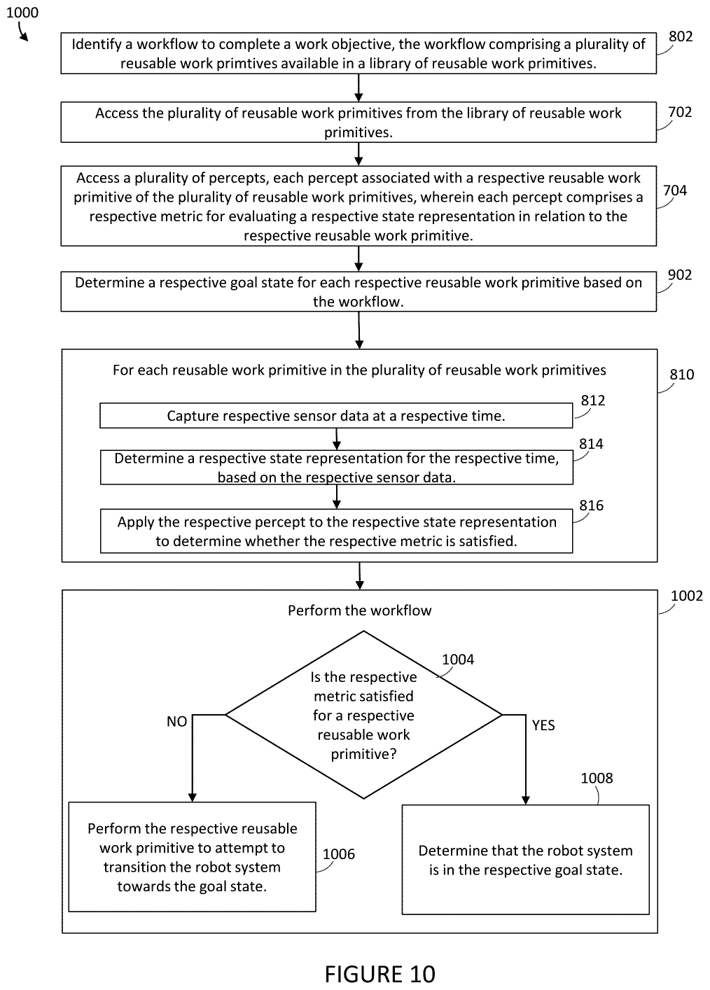

At 804, the workflow is performed. In some examples, performing the workflow comprises the robot controller executing each reusable work primitive in the plurality of reusable work primitives. In other examples, performing the workflow comprises the robot controller executing certain reusable work primitives in the plurality of reusable work primitives as needed in the context of the workflow (as discussed later with reference to FIG. 10). As previously described, in some implementations the robot may be trained, configured, or otherwise operable to perform reusable work primitives in the library of reusable work primitives substantially autonomously or automatically. For example, a non-transitory processor-readable storage medium of the robot system may store respective sets of processor-executable instructions that, when executed by at least one processor of the robot system, each cause the robot system to autonomously perform a respective one of the reusable work primitives in the first library of work primitives. Thus, when the robot controller executes the first workflow at 804, the robot controller may do so substantially autonomously or automatically by executing the sets of processor-executable instructions that cause or enable the robot system to autonomously perform the particular reusable work primitives in the plurality of reusable work primitives that correspond to the workflow.

At 810, certain sub-acts are performed for each reusable work primitive in the plurality of respective work primitives, including sub-acts 812, 814, and 816 in the illustrated example. At 812, respective sensor data is captured for a respective time (pertinent to the particular reusable work primitive for which the sensor data is being captured). As one example, for post-condition evaluation, the respective time for each reusable work primitive comprises a time after executing the reusable work primitive. As another example, for pre-condition evaluation, the respective time for each reusable work primitive comprises a time prior to executing the reusable work primitive. These examples are discussed in more detail later. Capturing of the sensor data is similar to as described earlier with reference to act 206 in method 200, and the description is not repeated for brevity.

At 814, a respective state representation is determined by the at least one processor for the respective time, based on the respective sensor data captured at 812. Determining a state representation is similar to as discussed earlier with reference to act 208 in method 200, and the description is not repeated for brevity.

At 816, the respective percept is applied by the at least one processor to the respective state representation to determine whether the respective metric is satisfied. Applying a percept is similar to as discussed earlier with reference to act 210 in method 200, and the description is not repeated for brevity.

In view of the above, act 810 entails capturing sensor data for each reusable work primitive in the plurality of reusable work primitives, determining a respective state representation pertinent to each reusable work primitive, and applying each respective percept to determine whether each metric is satisfied.

The order of acts illustrated in method 800 is not strictly limiting. As one example, act 804 is illustrated earlier than acts 810; but in practice sub-acts 812, 814, and 816 (of acts 810) can be performed interspersed with execution of reusable work primitives as part of performing the workflow in act 804.

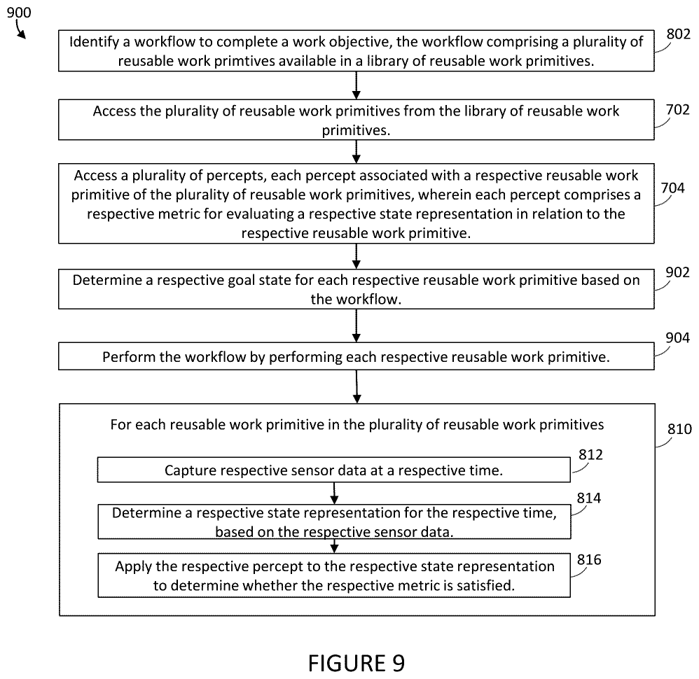

FIG. 9 is a flow diagram showing an exemplary method 900 of operation of a robot system. Method 900 in FIG. 9 is similar to and expands on method 200 in FIG. 2, method 700 in FIG. 7, and method 800 in FIG. 8. Description of method 200 in FIG. 2, method 700 in FIG. 7, and method 800 in FIG. 8 is fully applicable to method 900 in FIG. 9 unless context dictates otherwise. Method 900 as illustrated includes acts 802, 702, 704, 902, 904, and 810 (including sub-acts 812, 814, and 816), though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 802, a workflow is identified to complete a work objective, similar to as discussed above regarding method 800, and not repeated for brevity.

At 702, the plurality of reusable work primitives are accessed from the library of reusable work primitives, similar to as discussed above for method 700, and not repeated for brevity.

At 704, a plurality of percepts are accessed by the at least one processor. Each percept in the plurality of percepts is associated with a respective reusable work primitive of the plurality of reusable work primitives accessed at 702. Each percept comprises a respective metric for evaluating a respective state representation in relation to the respective reusable work primitive. Accessing the plurality of percepts is similar to accessing the plurality of percepts in act 704 discussed with reference to method 700, and description of act 704 in method 700 is fully applicable to act 704 in method 900.

At 902, a respective goal state for each respective reusable work primitive is determined by the at least one processor based on the workflow. Determining of a goal state is similar to as discussed earlier with reference to act 404, and is fully applicable to act 902. In this context, a goal state for a given reusable work primitive is a desired state for the robot body or aspect of the robot body after successful execution of the reusable work primitive.

At 904, the workflow is performed, similar to as described above with reference to act 804 in method 800. In this example, performing the workflow comprises performing each reusable work primitive in the plurality of reusable work primitives. Stated differently, each reusable work primitive is executed to attempt to transition the robot system towards the respective goal state as part of performing the workflow.

At 810, certain sub-acts are performed for each reusable work primitive in the plurality of respective work primitives, including sub-acts 812, 814, and 816 in the illustrated example, similar to as discussed above with reference to sub-acts 812, 814, and 816 in method 800.

At 812, respective sensor data is captured for a respective time (pertinent to the particular reusable work primitive for which the sensor data is being captured). In this example, the respective time for each reusable work primitive comprises a time after executing the reusable work primitive. Capturing of the sensor data is similar to as described earlier with reference to act 206 in method 200, and the description is not repeated for brevity.

At 814, a respective state representation is determined by the at least one processor for the respective time, based on the respective sensor data captured at 812. Determining a state representation is similar to as discussed earlier with reference to act 208 in method 200, and the description is not repeated for brevity.

At 816, the respective percept is applied by the at least one processor to the respective state representation to determine whether the respective metric is satisfied. Applying a percept is similar to as discussed earlier with reference to act 210 in method 200, and the description is not repeated for brevity.

In view of the above, act 810 in method 900 entails capturing sensor data for each reusable work primitive in the plurality of reusable work primitives, determining a respective state representation pertinent to each reusable work primitive, and applying each respective percept to determine whether each metric is satisfied. In the context of method 900, sub-acts 812, 814, and 816 (of acts 810) can be performed interspersed with execution of each reusable work primitive as part of performing the workflow in act 904. In particular, after execution of a particular reusable work primitive at 904, sub-acts 812, 814, and 816 are performed to evaluate performance of the particular reusable work primitive. This can be performed for each reusable work primitive in the plurality of reusable work primitives, to verify performance of the workflow as a whole. In this sense, method 900 in FIG. 9 illustrates an example of post-condition checking, similar to as discussed above with reference to FIG. 4.

FIG. 10 is a flow diagram showing an exemplary method 1000 of operation of a robot system. Method 1000 in FIG. 10 is similar to and expands on method 200 in FIG. 2, method 700 in FIG. 7, method 800 in FIG. 8, and method 900 in FIG. 9. Description of method 200 in FIG. 2, method 700 in FIG. 7, method 800 in FIG. 8, and method 900 in FIG. 9 is fully applicable to method 1000 in FIG. 10 unless context dictates otherwise. Method 1000 as illustrated includes acts 802, 702, 704, 902, 810 (including sub-acts 812, 814, and 816), and 1002 (including sub-acts 1006 and 1008), though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 802, a workflow is identified to complete a work objective, similar to as discussed above regarding method 800, and not repeated for brevity.

At 702, the plurality of reusable work primitives are accessed from the library of reusable work primitives, similar to as discussed above for method 700, and not repeated for brevity.

At 704, a plurality of percepts are accessed by the at least one processor. Each percept in the plurality of percepts is associated with a respective reusable work primitive of the plurality of reusable work primitives accessed at 702. Each percept comprises a respective metric for evaluating a respective state representation in relation to the respective reusable work primitive. Accessing the plurality of percepts is similar to accessing the plurality of percepts in act 704 discussed with reference to method 700, and description of act 704 in method 700 is fully applicable to act 704 in method 1000.

At 902, a respective goal state for each respective reusable work primitive is determined by the at least one processor based on the workflow. Determining of a goal state is similar to as discussed earlier with reference to act 404, and is fully applicable to act 902 in method 1000. In this context, a goal state for a given reusable work primitive is a desired state for the robot body or aspect of the robot body after successful execution of the reusable work primitive.

At 810, certain sub-acts are performed for each reusable work primitive in the plurality of respective work primitives, including sub-acts 812, 814, and 816 in the illustrated example, similar to as discussed above with reference to sub-acts 812, 814, and 816 in method 800.

At 812, respective sensor data is captured for a respective time (pertinent to the particular reusable work primitive for which the sensor data is being captured). In this example, the respective time for each reusable work primitive comprises a time prior to executing the reusable work primitive, and in this regard method 1000 pertains to pre-condition evaluation similar to method 500 in FIG. 5 discussed earlier. Capturing of the sensor data is similar to as described earlier with reference to act 206 in method 200, and the description is not repeated for brevity.

At 814, a respective state representation is determined by the at least one processor for the respective time, based on the respective sensor data captured at 812. Determining a state representation is similar to as discussed earlier with reference to act 208 in method 200, and the description is not repeated for brevity.

At 816, the respective percept is applied by the at least one processor to the respective state representation to determine whether the respective metric is satisfied. Applying a percept is similar to as discussed earlier with reference to act 210 in method 200, and the description is not repeated for brevity.

At 1002, the workflow is performed. In particular, at 1004, if the respective metric is not satisfied for a particular reusable work primitive, method 1000 proceeds to act 1006, where the respective reusable work primitive is performed to attempt to transition the robot system towards the respective goal state for the respective reusable work primitive. On the other hand, at 1004 if the respective metric is satisfied for a particular reusable work primitive, method 1000 proceeds to act 1008, where the robot system is determined as being in the respective goal state (without needing to perform the respective reusable work primitive).

In view of the above, act 810 in method 1000 entails capturing sensor data for each reusable work primitive in the plurality of reusable work primitives, determining a respective state representation pertinent to each reusable work primitive, and applying each respective percept to determine whether each metric is satisfied. In the context of method 1000, sub-acts 812, 814, and 816 (of acts 810) can be performed interspersed with execution of each reusable work primitive as part of performing the workflow in act 1002. In particular, a particular reusable work primitive can be performed at 1002 if at 816 the respective metric is determined as not being satisfied. This can be undertaken for each reusable work primitive in the plurality of reusable work primitives, to verify performance of the workflow as a whole, while avoiding needless or excessive performing of work primitives for which an associated metric is already satisfied. Method 1000 in FIG. 10 illustrates an example of pre-condition checking, similar to as discussed above with reference to FIG. 5.

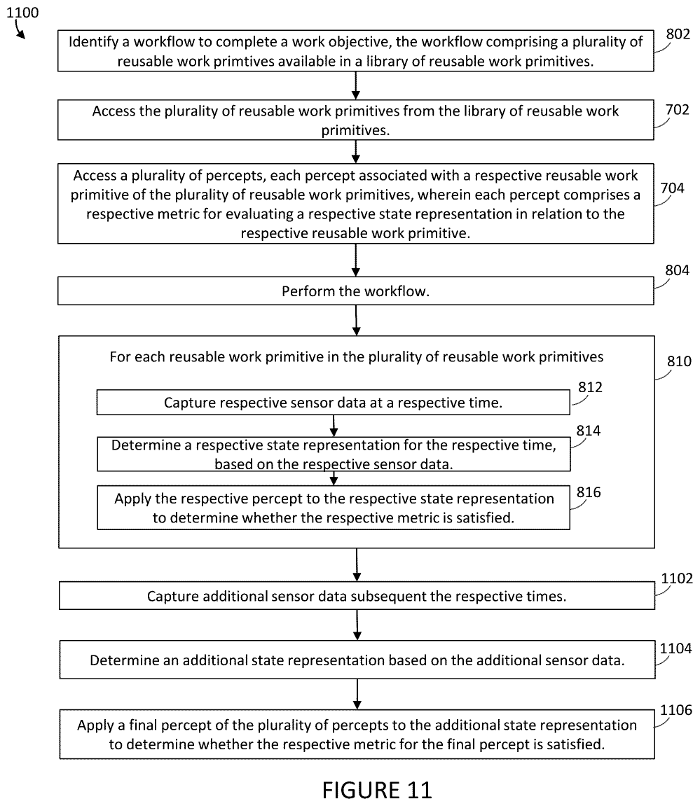

FIG. 11 is a flow diagram showing an exemplary method 1100 of operation of a robot system. Method 1100 in FIG. 11 is similar to and expands on method 200 in FIG. 2, method 700 in FIG. 7, and method 800 in FIG. 8. Description of method 200 in FIG. 2, method 700 in FIG. 7, and method 800 in FIG. 8 is fully applicable to method 1100 in FIG. 11 unless context dictates otherwise. Method 1100 as illustrated includes acts 802, 702, 704, 804, 810 (including sub-acts 812, 814, and 816), 1102, 1104, and 1106, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

Acts 802, 702, 704, 804, and 810 (including sub-acts 812, 814, and 816) in FIG. 11 are as described with reference to method 800 in FIG. 8, and the description is not repeated for brevity.

Acts 1102, 1104, and 1106 are performed after the acts of method 800 (or after the acts of method 900 in FIG. 9 or method 1000 in FIG. 10, in some implementations), and serve to evaluate maintenance of state, similarly to as discussed earlier with reference to FIG. 6.

At 1102, the at least one sensor captures additional sensor data subsequent the respective times for each reusable work primitive discussed with reference to 810. Capturing of sensor data is similar to as described earlier for at least act 206 in method 200, 400, 500, 600, and 700, and sub-acts 812 in methods 800, 900, and 1000, and is not repeated for brevity.

At 1104, the at least one processor determines an additional state representation based on the additional sensor data. Determination of a state representation is similar to as discussed earlier with reference to acts 208, 604, 814, in methods 200, 400, 500, 600, 700, 800, 900, and 1000, and is not repeated for brevity.

At 1106, the at least one processor applies a final percept of the plurality of percepts to the additional state representation to determine whether the respective metric for the final percept is satisfied. Application of percepts to determine satisfaction of metrics is as discussed earlier with reference to acts 210, 606, 710, and 816, in methods 200, 400, 500, 600, 700, 800, 900, and 1000, and is not repeated for brevity.

In the context of method 1100, what is meant by “final percept” is the last sequential percept in the plurality of percepts; that is, the percept which includes a metric indicative of a final state the robot system should be in after performing the workflow. By applying this percept at the end of method 1100, maintenance of this final state is evaluated.

Similar to as discussed earlier with reference to FIG. 7, methods 800, 900, 1000, and 1100 in FIGS. 8, 9, 10, and 11 can further comprise determining whether a combined metric is satisfied based on whether the respective metrics of the respective percepts are satisfied. Such a combined metric is represented by the plurality of percepts and is for evaluating whether a combined state representation in relation to the work objective is satisfied. In general, each percept and/or metric can comprise a Boolean function which returns either true or false. Further, a combined metric can comprise a Boolean function which takes each percept or metric as input. Equations (1) and (2) discussed earlier are examples of such Boolean functions, and the discussion thereof is fully applicable to methods 800, 900, 1000, and 1100 in FIGS. 8, 9, 10, and 11.

In one exemplary implementation similar as discussed earlier with reference to Equation (1), determining whether a combined metric is satisfied comprises determining whether each applied metric is satisfied. In this example, the combined metric is satisfied if each respective state representation satisfies the respective metric of the respective precept, as applied to the respective state representation in acts 816. Conversely in this example, the combined metric is NOT satisfied if at least one respective state representation does NOT satisfy the respective metric of the respective precept, as applied to the respective state representation in acts 816. That is, in this example, the combined metric is satisfied if each metric making up part of the combined metric is satisfied, whereas the combined metric is not satisfied if at least one metric making up part of the combined metric is not satisfied.

In another exemplary implementation similar to as discussed earlier with reference to Equation (2), a combined metric can be a Boolean function which takes indications of metric satisfaction or metric non-satisfaction for each respective percept as input. Such a function can be tailored to accommodate any appropriate metric results, and does not require an indication of metric satisfaction for each metric in order for the combined metric to be satisfied, as discussed earlier. In the context of method 800, 900, 1000, and 1100, acts 816 of applying the respective percept to the respective state representation to determine whether the respective metric is satisfied can further comprise outputting an indication of metric satisfaction for the respective percept if the respective state representation satisfies the respective metric, and/or can further comprise outputting an indication of metric non-satisfaction for the respective percept if the respective state representation does not satisfy the respective metric.

Various exemplary methods 200, 400, 500, 600, 700, 800, 900, 1000, and 1100 of operation of a robot are described herein. As discussed earlier, a method of operation of a robot system is a method in which at least some, if not all, of the various acts are performed by the robot system. For example, certain acts of a method of operation of a robot body may be performed by at least one processor or processing unit (hereafter “processor”) of the robot body communicatively coupled to a non-transitory processor-readable storage medium of the robot body and, in some implementations, certain acts of a method of operation of a robot system may be performed by peripheral components of the robot body that are communicatively coupled to the at least one processor, such as one or more physically actuatable components (e.g., arms, legs, end effectors, grippers, hands), one or more sensors (e.g., optical sensors, audio sensors, tactile sensors, haptic sensors), mobility systems (e.g., wheels, legs), communications and networking hardware (e.g., receivers, transmitters, transceivers), and so on. The non-transitory processor-readable storage medium of the robot body may store data (including, e.g., at least one library of reusable work primitives) and/or processor-executable instructions that, when executed by the at least one processor, cause the robot body to perform the method and/or cause the at least one processor to perform those acts of the method that are performed by the at least one processor. The robot body may communicate, via communications and networking hardware communicatively coupled to the robot's at least one processor, with remote systems and/or remote non-transitory processor-readable storage media. Thus, unless the specific context requires otherwise, references to a robot system's non-transitory processor-readable storage medium, as well as data and/or processor-executable instructions stored in a non-transitory processor-readable storage medium, are not intended to be limiting as to the physical location of the non-transitory processor-readable storage medium in relation to the at least one processor of the robot and the rest of the robot hardware. In other words, a robot system's non-transitory processor-readable storage medium may include non-transitory processor-readable storage media located on-board the robot body (such as memory 140) and/or non-transitory processor-readable storage media located remotely from the robot body (such as memory 172), unless the specific context requires otherwise. Further, a method of operation of a robot system such as any of methods 200, 400, 500, 600, 700, 800, 900, 1000, and 1100 can be implemented as a computer program product or robot control module. Such a computer program product or robot control module comprises processor-executable instructions or data that, when the computer program product or robot control module is stored on a non-transitory processor-readable storage medium of the robot system, and the computer program product or robot control module is executed by at least one processor of the robot, the computer program product or robot control module (or the processor-executable instructions or data thereof) cause the robot system to perform acts of the method.

In some implementations, each of the acts of any of the methods discussed herein (200, 400, 500, 600, 700, 800, 900, 1000, and 1100) are performed by hardware of the robot body, such that the entire method is performed locally at the robot body. In such implementations, accessed data (such as reusable work primitives or percepts) can be accessed from a non-transitory processor-readable storage medium at the robot body (e.g. a non-transitory processor-readable storage medium of a robot controller local to the robot body such as memory 140). Alternatively, accessed data (such as reusable work primitives or percepts) can be accessed from a non-transitory processor-readable storage medium remote from the robot (e.g., a remote device can send the data, which is received by a communication interface of the robot body).

In other implementations, the robot system includes a remote device (such as teleoperation device 170 in FIG. 1, or a remote processing server), which is communicatively coupled to the robot body by at least one communication interface. In such implementations, acts of capturing sensor data can be performed by at least one sensor positioned at the robot body, and this sensor data can be transmitted to the remote device via the at least one communication interface. In such implementations, acts of identifying, determining, executing work primitives or workflows, and applying percepts can be performed by a robot controller (at least one processor and at least one non-transitory processor-readable storage medium) located at the remote device.

The systems, methods, and computer program products described herein may, in some implementations, employ any of the teachings of the present systems, methods, control modules, and computer program products include, without limitation, the general-purpose humanoid robots developed by Sanctuary Cognitive Systems Corporation, various aspects of which are described in U.S. patent application Ser. No. 18/375,943, U.S. patent application Ser. No. 18/513,440, U.S. patent application Ser. No. 18/417,081, U.S. patent application Ser. No. 18/424,551, U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), U.S. Provisional Patent Application Ser. No. 63/001,755 (Publication No. US 2021-0307170 A1), and/or U.S. Provisional Patent Application Ser. No. 63/057,461, as well as U.S. Provisional Patent Application Ser. No. 63/151,044, U.S. Provisional Patent Application Ser. No. 63/173,670, U.S. Provisional Patent Application Ser. No. 63/184,268, U.S. Provisional Patent Application Ser. No. 63/213,385, U.S. Provisional Patent Application Ser. No. 63/232,694, U.S. Provisional Patent Application Ser. No. 63/316,693, U.S. Provisional Patent Application Ser. No. 63/253,591, U.S. Provisional Patent Application Ser. No. 63/293,968, U.S. Provisional Patent Application Ser. No. 63/293,973, and/or U.S. Provisional Patent Application Ser. No. 63/278,817, each of which is incorporated herein by reference in its entirety.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A method for operating a robot system including a robot body, a robot controller, and at least one sensor, the method comprising:
accessing, by the robot controller, a first reusable work primitive from a library of reusable work primitives;
accessing, by the robot controller, a first percept associated with the first reusable work primitive, wherein the first percept comprises a first metric for evaluating a state representation in relation to the first reusable work primitive;
capturing, by the at least one sensor, first sensor data at a first time;
determining, by at least one processor of the robot controller, a first state representation for the first time, based on the first sensor data; and
applying, by the at least one processor, the first percept to the first state representation to determine whether the first metric is satisfied.

2. The method of claim 1, further comprising:
if the first metric is satisfied, outputting an indication of metric satisfaction; and
if the first metric is not satisfied, outputting an indication of metric non-satisfaction.

3. The method of claim 1, further comprising, prior to the first time:
capturing, by the at least one sensor, second sensor data at a second time before the first time;
determining, by the at least one processor, a goal state based on the second sensor data;
selecting, by the at least one processor, the first percept and the associated first reusable work primitive by identifying the first metric as indicative of whether the robot system is in the goal state; and
performing the first reusable work primitive to attempt to transition the robot system towards the goal state.

4. The method of claim 1, further comprising:
determining, by the at least one processor, a goal state;
selecting, by the at least one processor, the first percept and the associated first reusable work primitive by identifying the first metric as indicative of whether the robot system is in the goal state;
if the first state representation satisfies the first metric, determining that the robot system is in the goal state; and
if the first state representation does not satisfy the first metric, performing the first reusable work primitive to attempt to transition the robot system towards the goal state.

5. The method of claim 1, wherein the first percept is a Boolean function which returns either true or false.

6. The method of claim 1, wherein the first metric indicates a success state representation, and the first metric is satisfied if the first state representation matches the success state representation.

7. The method of claim 1, wherein the first metric indicates at least one failure condition, and the first metric is satisfied if the first state representation does not fulfill any of the at least one failure condition.

8. The method of claim 1, wherein:
accessing a first reusable work primitive from a library of reusable work primitives comprises: accessing a plurality of reusable work primitives from the library of reusable work primitives, including the first reusable work primitive;
accessing the first percept comprises: accessing a plurality of percepts including the first percept, each percept of the plurality of percepts associated with a respective reusable work primitive of the plurality of reusable work primitives, wherein each percept comprises a respective metric for evaluating a respective state representation in relation to the respective reusable work primitive;
applying the first percept to the first state representation comprises, for each percept in the plurality of percepts:
applying the respective percept to at least one respective aspect of the first state representation to determine whether the respective metric is satisfied; and
the method further comprises determining, by the at least one processor, whether the first state representation satisfies a combined metric represented by the plurality of percepts, based on whether the respective metrics are satisfied.

9. The method of claim 8, wherein determining whether the first state representation satisfies the combined metric comprises:
determining that the first state representation satisfies the combined metric if each respective aspect of the first state representation satisfies the respective metric of the respective percept applied to the respective aspect of the first state representation; and
determining that the first state representation does not satisfy the combined metric if at least one respective aspect of the first state representation does not satisfy the respective metric of the respective percept applied to the respective aspect of the first state representation.

10. The method of claim 8, wherein:
applying the first percept to the first state representation comprises, for each percept in the plurality of percepts:
if the at least one respective aspect of the first state representation satisfies the respective metric, outputting an indication of metric satisfaction; and
if the at least one respective aspect of the first state representation does not satisfy the respective metric, outputting an indication of metric non-satisfaction; and
determining whether the first state representation satisfies a combined metric represented by the plurality of percepts comprises determining whether the first state representation satisfies the combined metric based on respective indications of metric satisfaction or metric non-satisfaction for each percept.

11. The method of claim 10, wherein:
determining whether the first state representation satisfies the combined metric comprises: evaluating a Boolean logic function which takes the indications of metric satisfaction or metric non-satisfaction for each respective aspect of the first state representation as input.

12. The method of claim 1, further comprising:
capturing, by the at least one sensor, second sensor data at a second time subsequent the first time;
determining, by the at least one processor, a second state representation for the second time, based on the second sensor data; and
applying, by the at least one processor, the first percept to the second state representation to determine whether the first metric is satisfied.

13. A method for operating a robot system including a robot body, a robot controller, and at least one sensor, the method comprising:
identifying, by the at least one processor, a workflow to complete a work objective, the workflow comprising a plurality of reusable work primitives available in a library of reusable work primitives;
accessing, by the robot controller, each reusable work primitive in the plurality of reusable work primitives;
accessing, by the robot controller, a plurality of percepts, each percept in the plurality of percepts associated with a respective reusable work primitive in the plurality of reusable work primitives, each percept in the plurality of percepts comprising a respective metric for evaluating a state representation in relation to the respective reusable work primitive; and
performing the workflow,
wherein for each reusable work primitive in the plurality of reusable work primitives, the method further comprises:
capturing, by the at least one sensor, respective sensor data at a respective time;
determining, by the at least one processor, the respective state representation of for the respective time, based on the respective sensor data; and
applying the respective percept to the respective state representation to determine whether the respective metric is satisfied.

14. The method of claim 13, further comprising, for each reusable work primitive in the plurality of reusable work primitives, prior to each respective time:
determining, by the at least one processor, a respective goal state for the respective reusable work primitive based on the workflow; and
performing the respective reusable work primitive to attempt to transition the robot system towards the respective goal state as part of performing the workflow.

15. The method of claim 13, further comprising, for each reusable work primitive in the plurality of reusable work primitives:
determining, by the at least one processor, a respective goal state;
if the respective state representation satisfies the respective metric, determining that the robot system is in the respective goal state; and
if the respective state representation does not satisfy the respective metric, performing the respective reusable work primitive to attempt to transition the robot system towards the respective goal state as part of performing the workflow.

16. The method of claim 13, wherein each percept is a Boolean function which returns either true or false.

17. The method of claim 13, wherein:
The method further comprises determining whether a combined metric is satisfied based on whether the respective metrics are satisfied; and
the combined metric is represented by the plurality of percepts and is for evaluating whether a combined state representation in relation to the work objective is satisfied.

18. The method of claim 17, wherein determining whether the combined metric is satisfied comprises:
determining that the combined metric is satisfied if each respective state representation satisfies the respective metric of the respective percept applied to the respective state representation; and
determining that the combined metric is not satisfied if at least one respective state representation does not satisfy the respective metric of the respective percept applied to the respective state representation.

19. The method of claim 17, wherein:
for each reusable work primitive in the plurality of reusable work primitives, applying the respective percept to the respective state representation comprises, for each reusable work primitive in the plurality of reusable work primitives:
if the respective state representation satisfies the respective metric, outputting an indication of metric satisfaction for the respective percept; and
if the respective state representation does not satisfy the respective metric, outputting an indication of metric non-satisfaction for the respective percept; and
determining whether the combined metric is satisfied comprises: determining whether the combined metric is satisfied based on respective indications of metric satisfaction or metric non-satisfaction for each percept.

20. The method of claim 13, further comprising:
capturing, by the at least one sensor, additional sensor data subsequent the respective times;
determining, by the at least one processor, an additional state representation based on the additional sensor data; and
applying, by the at least one processor, a final percept of the plurality of percepts to the additional state representation to determine whether the respective metric for the final percept is satisfied.
